(19) United States
(12) Patent Application Publication
(10) Pub. No.: US 2016/0150732 A1
(43) Pub. Date: Jun. 2, 2016

(54) Conditioner For Hay And Other

(71) Applicant: Solerajah Pty Ltd., Sunnyside (AU)

(72) Inventor: William Brian Dale, Sunnyside (AU)

(21) Appl. No.: 14/959,515

(22) Filed: Dec. 4, 2015

Related U.S. Application Data
(63) Continuation-in-part of application No. PCT/AU2014/000566, filed on May 30, 2014.

(30) Foreign Application Priority Data
Jun. 5, 2013 (AU) 2013902030
Oct. 1, 2013 (AU) 2013903789

(51) Int. Cl. A01D 82/00

(52) U.S. Cl. CPC A01D 82/00

(57) ABSTRACT

A hay conditioner including a draw frame mounting at least one pair of counter-rotating rotors, each rotor having a number of blades in order to braise the hay and to convey the hay at least into a throat located between the pair of rotors.

### CROSS-REFERENCE TO RELATED APPLICATIONS

The present application claims priority to and is a continuation-in-part of International Patent Application PCT/AU2014/000566, which claims priority to Australian Patent Application No. 2013902030, filed on Jun. 5, 2013 in Australia, entitled “A CONDITIONER FOR HAY AND OTHER” and to Australian Patent Application No. 2013903789, filed on Oct. 1, 2013 in Australia, entitled “A CONDITIONER FOR HAY AND OTHER.”

### TECHNICAL FIELD

The present invention relates generally to agricultural equipment and in particular to a hay conditioner.

### BACKGROUND ART

The conventional hay making process requires the crop to be cut with a mower conditioner after the overnight dew and or rain has evaporated from the crop. A mower conditioner cuts the crop of hay with the hay then being fed between two rubber rollers which bruises the hay to aid in the drying by allowing moisture to escape from within the stalks of hay. Another method used instead of rollers is spinning shafts with fingers attached to again bruise the product to aid in drying. All the various types of mower conditioners leave the hay in a thick layer on the ground which only allows the top layer of hay to dry. After the top layer of hay has dried sufficiently a hay rake is used to turn the hay over into a wind row exposing a portion of the undried hay from underneath to be dried by sun and wind.

This process leaves portions of the undried grass underneath and in the middle of the wind row not allowing them to dry. Other already dry portions will be left on top of the wind row subject to excessive drying and sun bleaching. Using a hay rake only, this process must be repeated up to three times a day for a further two to four days depending on climatic conditions.

One conventional machine directed to ameliorating this problem is called Tedder™. The Tedder™ has rotating fingers that spread the hay after it has been raked into a wind row to aid the drying and curing process but portions of undried hay are still left close to the ground so the hay must be raked into a wind row again and then the Tedder™ is used to spread the hay once again. The Tedder™ does not remove visible moisture that is, dew or rain from the hay.

Currently, the drying and curing process cannot be achieved in the same day the crop is cut with the machines manufactured by any of the agricultural machinery companies.

Therefore, once again, the day after the dew and or overnight rain has evaporated from the top of each row the raking of the hay has to be repeated until the moisture level is reduced in the hay. The Tedder™ may once again have to be used to spread the hay and then raked again for the baling process to begin.

Even with the use of the Tedder™ it would take at least two days with optimal drying conditions to reduce the moisture content sufficiently for baling of the hay.

The drying and curing process of hay currently requires on average, two to four days or even longer in some instances to achieve the correct moisture level in the hay before the baling process can commence. The longer this process takes greatly reduces the bulk, quality and nutritional value of the hay. If this process of drying takes too long, the crop of hay will be lost.

During this time, on any given day of the drying process, if a large enough amount of rain falls the crop will also be lost, therefore, a weather window of at least four days is required before cutting the crop.

Further, a crop must be cut at the correct period of its growth to obtain maximum nutritional value and without the weather window of at least four days this cannot always be achieved as not only the hay must be baled but it must be removed from the paddock, transported and stored during this period.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a hay conditioner, which may at least partially overcome at least one of the abovementioned disadvantages or provide the consumer with a useful or commercial choice.

With the foregoing in view, the present invention in one form, resides broadly in hay conditioner including a frame mounting at least one pair of counter-rotating rotors, each rotor having a number of blades in order to bruise the hay and to convey the hay at least into a throat located between the pair of rotors.

In an alternative aspect, the present invention resides in a rotor for conditioning material, the rotor including a central body, a lower skid plate mounted to the body and at least one rotor blade assembly mounted to the central body above the skid plate, the rotor positioned and oriented in use closer to a ground surface at a forward side than a rearward side to lift and propel material from adjacent a ground surface in a desired direction.

Whilst termed a “hay conditioner”, the present invention can be used to at least partially condition any crop that requires drying after being cut.

The hay conditioner of the present invention only needs a weather window of one day which means not only can a crop be cut at the right time for bulk, quality and nutritional value but there is less chance of losing nutritional value of the hay as the drying time is much quicker and the hay does not sun bleach. Labour and machinery hours are greatly reduced.

The present hay conditioner does not have to rely on the overnight dew and or moisture from rain to be evaporated from the crop before cutting can commence. A mower conditioner can cut the crop while still laden with moisture and the hay conditioner follows immediately behind the mower without waiting for the top layer of grass to dry.

The rotors of the hay conditioner create air flow which lifts and draws hay into the centre and in front of the two rotors. The hay is then drawn between the two rotors and discharged out of the rear of the machine.

As the hay is drawn through between the pair of rotors, the blades further bruise the hay to assist in the drying and curing process. This action dissipates visible moisture from the hay as well as dissipating some moisture, if any, from the ground in front of the rotors.

The hay is spread approximately eight metres behind the machine and three to five metres wide leaving the hay in a fluffed up state to allow the sun and or breeze to dry one hundred percent of the hay evenly. This drying process usually takes between two to six hours depending on climatic conditions and the type of crop being cut.

The hay is then raked into a wind row ready for baling which can commence immediately. Therefore, the hay is cut, conditioned, dried, cured, baled, transported and stored all in one day. As this process is done all in one day the bulk, quality and nutritional value of the hay is far greater than hay made on the fourth, third or even the second day after cutting with the currently available machinery.

The pair of rotors of the hay conditioner of the present invention are typically multipurpose rotors adapted to hasten drying of the hay by bruising the hay but also providing airflow which is used to draw the hay up off the ground assisting the drying process and also spreading the partially dried hay evenly behind the hay conditioner in order to facilitate faster drying of the hay.

In some embodiments of the invention, at least one of the pair of rotors may be provided with one or more spreader members. The spreader members may be of any suitable form, although in a preferred embodiment of the invention the one or more spreader members may be adapted to enhance the drying and/or distribution of the cut hay. The use of the one or more spreader members allows the hay conditioner to travel at an increased velocity without adversely affecting the separation of the clumps of hay and still spreading it evenly.

The spreader members may be of any suitable size, shape or configuration. However, in a preferred embodiment of the invention, the one or more spreader members may be attached to a blade of at least one of the pair of rotors. In some embodiments, one or more spreader members may be attached to each of the blades of at least one of the pair of rotors. In other embodiments, one or more spreader members may be attached to at least one blade of each of the pair of rotors.

The one or more spreader members may be provided at any suitable location on the blade of the rotor, and may be located on either side of the blade (for instance, depending on the direction of rotation of the rotor and so on).

In a preferred embodiment of the invention, the one or more spreader members comprise elongate members that extend outwardly at least in part from an edge of the blade of the rotor. In embodiments of the invention in which two or more spreader members are present, the two or more spreader members may be located spaced apart from one another at any suitable distance, and at any suitable angle to one another. Preferably, the angle of the one or more spreader members relative to the blade of the rotor may be adjusted depending on the type of grass being cut, the moisture of the grass and so on.

The one or more spreader members may be of any suitable cross-sectional shape, and the exact cross-sectional shape of the one or more spreader members is not critical. In a preferred embodiment of the invention, the one or more spreader members may be fabricated from a relatively rigid material, such as, but not limited to metal.

In preferred embodiments of the invention 1 to 5 spreader members may be located on at least one blade of at least one rotor.

The hay conditioner of the present invention includes a draw frame. Typically, the draw frame will allow the hay conditioner to be drawn behind a vehicle which will traverse over an area of ground in which hay has been cut. Normally, the vehicle will be a tractor or similar vehicle.

Other equipment may be interposed between the hay conditioner of the present invention and the drawing vehicle and/or the hay conditioner may be followed by other equipment. In particular, a mower conditioner may be interposed between the draw vehicle and the hay conditioner.

The draw frame of the present invention may be of any configuration which is suitable to allow the hay conditioner to be drawn or otherwise mounted relative to a vehicle to draw or otherwise move the conditioner. Typically, the draw vehicle will have a three point linkage or similar provided thereon. Therefore, the draw frame will typically be adapted to mount to this linkage on the draw vehicle.

According to a particularly preferred embodiment, a main drive mounting frame is provided as a part of the draw frame. The main drive mounting frame will typically mount the main drive pulley provided as a part of a preferred embodiment of the present invention. The main drive pulley will preferably be driven by the power takeoff (PTO) mechanism provided on the draw vehicle.

Gearing may be provided in order to obtain a required torque or revolution speed at the pair of rotors.

Normally, the main drive mounting frame is substantially A-frame in configuration but normally with a flattened upper and/or lower section. Normally the main drive mounting frame is oriented in a substantially vertical plane. Typically, the main drive pulley will rotate around a transverse shaft which extends rearwardly of the preferred main drive mounting frame.

The main drive mounting frame is typically formed from a number of members, normally of metal box or similar, which are attached together to form the frame. According to a preferred embodiment, the lower member of the main drive mounting frame typically extends substantially horizontally across a lower extremity of the main drive mounting frame below the lowest extremity of the main drive pulley in order to protect the main drive pulley and prevent contact of the main drive pulley with the ground or hay on the ground.

A laterally extending fame assembly is typically provided extending laterally from the main drive mounting frame.

A main lateral bar or similar structure will preferably extend laterally sideways from one side of the A-frame main drive mounting frame. A main lateral bar may be provided extending on both sides of the main drive mounting frame but preferably only to one side.

The main lateral bar will typically be braced into a particular orientation relative to the main drive mounting frame through provision of one or more bracing members. Normally, an upper and a lower bracing member are provided relative to the main lateral bar. Each of these upper and lower members is normally angled to brace the main lateral bar into a substantially horizontal orientation.

A lateral arm is normally provided mounted to or relative to the main lateral bar on an outer end of the main lateral bar. Normally, the lateral arm is mounted directly to the main lateral bar. An appropriate joining or mounting assembly is typically used and a preferred embodiment uses a flange join with one or more fasteners extending through mating flanges on the main lateral bar and the lateral arm.

Typically, a secondary drive pulley is mounted on the lateral arm. Normally, the secondary drive pulley is mounted outboard of the join between the lateral arm and the main lateral bar.

Alternatively, a sleeve fitting is provided on the main lateral bar into which a portion of the lateral arm is fitted and/or a lateral arm sleeve can be provided to fit over a portion of the main lateral bar.

At least one pivot is typically provided over the length of the laterally extending frame assembly. Preferably, a horizontal pivot is provided and a vertical pivot is provided allowing a portion of the laterally extending frame assembly to move in both a horizontal direction and a vertical direction. Preferably, an outer arm is provided relative to which the rotors are mounted and the outer arm is typically movable about a pivot in a vertical direction. An intermediate arm is typically pivotally mounted relative to the lateral arm allowing movement of the intermediate arm in the horizontal plane about the horizontal pivot. A combination of both of these pivots allows optimal positioning of the rotors through positioning of the outer arm relative to which the rotors are mounted. The intermediate arm preferably provides a vertical pivot at an outer end and a horizontal pivot at an inner end.

Preferably, the pivot allowing movement of the outer arm through a vertical plane may be powered in order to allow remote lifting of the outer arm with the rotors mounted thereto, toward and away from the ground surface. This will typically allow temporary reduction of the width of the vehicle which can be important in certain circumstances such as when turning the vehicle and also when storing the vehicle with the hay conditioner mounted thereto. It will also allow variation of the separation distance between the rotors and the ground surface.

According to a particularly preferred embodiment, the pivot allowing movement of the outer arm through a vertical plane will be associated with a hydraulic or pneumatic ram to pivotally connect a pivot point on the main drive pulley frame and a pivot point on the outer arm allowing movement of the outer arm. Shortening of the ram and arm will normally raise the outer arm and lengthening will lower the outer arm.

According to a particularly preferred embodiment, the lateral frame assembly includes four components extending laterally, namely the main lateral bar extending from the main drive frame, a lateral arm which is mounted to an end of the main lateral bar, an intermediate arm which is pivotally mounted to the lateral arm allowing movement in a horizontal plane and an outer arm which mounts the rotors which is pivotally attached to the intermediate arm allowing movement in a vertical plane.

According to the preferred embodiment, the components of the lateral frame assembly are all substantially coplanar and/or coaxial when the hay conditioner is in operation.

The main frame is preferably pivotally connected to the lateral frame assembly in order to reduce the stress imposed on the vehicle linkage.

Preferably, the outer arm mounts the pair of rotors. The outer arm also preferably mounts a cover assembly in order to control or direct air and/or hay as desired. The cover may also at least partially contain the air flow created by the rotors in order to lift and/or convey the hay. The cover assembly will preferably include a top cover to extend partially between the rotors, forwardly and laterally in order to minimise hay causing any problems with the drive for the rotors.

The cover assembly also preferably mounts a skirt portion to assist with the air control and direction. The skirt portion will typically be mounted relative to the top cover and will extend forwardly of the top cover and down in front of the rotors. The skirt is preferably flexible. A suitable material is a canvas or similar. The skirt will normally extend laterally across in front of the rotors.

A lower edge of the skirt is typically spaced from the plane of the skid plate so as not to obstruct the entry of the hay into the rotors.

The cover is normally shaped to direct and/or constrain the flow of air and hay typically into and through the rotors. The rear surface of the skirt may be angled inwardly at outer or lateral sides in order to limit the forward dispersion and/or lateral dispersion of the hay.

The cover assembly may further comprise one or more flow control members to control the flow of air and/or cut grass through the cover assembly. The one or more flow control members may be located at any suitable location within the cover assembly. However, in a preferred embodiment of the invention, the one or more flow control members may be located between the front of the cover assembly (i.e. the end of the cover assembly at which cut grass enters) and the pair of rotors. In this way, the one or more flow control members may control the flow of air (and cut grass carried by the air) through the cover assembly and into the rotors. By doing this, the efficiency with which the cut grass is dried may be significantly increased.

The one or more flow control members may be of any suitable size, shape or configuration. Preferably, however, the one or more flow control members extend substantially laterally across the cover assembly (i.e. between opposed side walls of the cover assembly). Thus, the one or more flow control members are positioned substantially perpendicular to the direction of flow of cut grass through the cover assembly.

While any suitable number of flow control members may be used, in a preferred embodiment of the invention, a single flow control member may extend substantially laterally across at least a portion of the width of the cover assembly. More preferably, a single flow control member may extend substantially laterally across substantially the entire width of the cover assembly. More than one flow control member can be used in a parallel or series configuration.

In a preferred embodiment of the invention, the flow control members have an aerofoil shape when viewed from an end thereof. By providing the flow control members with an aerofoil shape, air carrying cut grass through the cover assembly may be accurately drawn into the pair of rotors for drying, thereby increasing the efficiency of the drying process.

In a preferred embodiment, the angle of the flow control members relative to the ground may be adjustable. In this way, the air flow through the cover assembly may be altered as required (for instance, for different types of grasses, for grasses having different moisture contents and the like). By adjusting the angle of the flow control members relative to the ground, the velocity and angle at which the cut grass is introduced to the pair of rotors may be varied.

The rotors are typically mounted for rotation about a substantially vertical axis although the angle of attack or pitch of the rotor relative to the ground surface and/or the spacing of one or more rotors in the pair is typically adjustable as required.

The hay conditioner of the present invention includes at least a pair of counter-rotating rotors. Normally, the counter-rotating rotors are provided in pairs. Therefore, there will normally be multiples of two, counter-rotating rotors in each hay conditioner. More than one pair of counter-rotating rotors can be provided for greater coverage or an extended lateral range.

The counter-rotating rotors preferably rotate such that a forward side of the rotors in the direction of travel converges rather than diverges. This will generally result in the rotors diverging at a rear side. Provision of the counter-rotating rotors in this configuration assists with drawing air and hay into the rotors at a forward side and helps to spread hay at the rear side.

Each rotor is preferably angled downwardly at a forward edge and upwardly at a rear edge, creating an angle of attack or pitch for each of the rotors. Normally the pitch of the rotors in each pair is substantially the same. The inclination or pitch of the rotors will typically assist with drawing the hay into and through the rotors as the vehicle traverses over the area having the cut hay on the ground. As mentioned above, this angle of attack or pitch is typically adjustable as is the clearance of the rotors from the cut hay and/or ground level.

Each rotor is preferably similar in configuration although due to the counter-rotating nature, the blade configuration on each rotor in a pair will normally be a mirror image of the other rotor in the pair. Each rotor typically includes a substantially cylindrical central pillar or portion with at least one, and normally a number of blades provided extending radially from the central pillar or portion. Normally, a substantially circular flange is provided at a lower end of the central pillar or portion. The circular flange preferably extends radially outwards as well with the blades mounted between the circular flange and the central pillar or portion. The circular flange may have a concave lower surface and may or may not have a convex upper surface.

A number of blades are preferably provided on each rotor. Normally, the blades are spaced about the central pillar or portion. Typically, each of the blades extends substantially tangentially relative to the circular central pillar or portion. According to the preferred embodiment, each blade extends to, or adjacent to, the edge of the circular flange.

Each blade will typically have a substantially planar inner edge which abuts and is normally attached to the cylindrical central pillar or portion. The outer edge of each of the blades is typically substantially planar and preferably coplanar with the edge of the circular flange. An upper edge of each blade extending between the outer edge and the inner edge is typically arcuate.

One or more bracing members and particularly, a bracing gusset may be provided behind each blade (in the direction of rotation of the rotor) in order to minimise or prevent flexing of the blade through contact with the hay. Preferably, each bracing gusset is a solid, triangular, substantially planar plate which is attached to both the blade and the circular flange normally approximately halfway across the width of the blade.

The particularly preferred embodiment of the rotor of the present invention includes four blades spaced evenly about the central pillar or portion.

Normally, the cylindrical central pillar or portion mounts a drive mechanism (or portion of a drive mechanism) in order to rotate the rotors. According to various embodiments, the drive mechanism may include one or more pulleys provided for a belt drive or one or more cogs provided for a chain drive. Alternatively, each rotor or pair of rotors may be directly driven by a hydraulic, pneumatic or an electric motor, or through the vehicle's power take off assembly, either through a gearbox or directly.

Preferably, each rotor inner rotor pair rotates at the same speed. However, different speeds may be used in order to distribute the conditioned hay exiting the rotors differently.

Each rotor is preferably mounted for rotation about a central shaft received through a bore in the central pillar or portion. Bearings will normally be provided for balanced rotation. As lower portion of the central shaft preferably mounts a skid plate which allows the hay conditioner to “ride” across a ground surface. Outer portions of the skid plate may be appropriately shaped to minimise or prevent the skid plate digging into the ground.

As mentioned above, air and hay normally travel together through each of the paired rotors.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an isometric view of the operation of a pair of rotors with top cover according to a preferred embodiment of the present invention.

FIG. 2 is a schematic plan view of a pair of rotors showing the directions of flow through the rotors according to a preferred embodiment of the present invention.

FIG. 2A is a schematic view of a portion of hay showing the impact points of the blades used to bruise the hay according to a preferred embodiment.

FIG. 3 is a schematic plan view of a pair of rotors according to a preferred embodiment showing the direction of rotation.

FIG. 4 is an axonometric view of the pair of rotors illustrated in FIG. 3.

FIG. 5 is a front axonometric view of a tractor or loader with the hay conditioner of a preferred embodiment mounted relative thereto.

FIG. 6 is a view from the rear of the configuration illustrated in FIG. 5.

FIG. 7 is a plan view of a hay conditioner according to a preferred embodiment of the present invention.

FIG. 8 is a plan view of an extended configuration of hay conditioner according to an alternative preferred embodiment of the present invention.

FIG. 9 is a view from the rear of the hay conditioner illustrated in FIG. 7 with the top cover in position.

FIG. 10 is a plan view of the hay conditioner illustrated in FIG. 9 with the top cover removed from the rotor assembly for clarity.

FIG. 11 is a view from the rear of the hay conditioner of a preferred embodiment attached to a tractor and in the operative condition.

FIG. 12 is a view from the rear of the hay conditioner illustrated in FIG. 11 with the outer arm mounting the rotor assembly raised away from the ground surface.

FIG. 13 is the same view as FIG. 12.

FIG. 13A is a detailed view of the portion illustrated on FIG. 13.

FIG. 14 shows the optional directions of flex between portions of the lateral frame assembly according to a preferred embodiment.

FIG. 15 is a plan view of a preferred embodiment of hay conditioner showing the drive belt configuration and rotation directions.

FIG. 16 is a plan view of an alternative preferred embodiment in which the rotors are driven by individually powered hydraulic motors.

FIG. 17 is a plan view of yet another alternative preferred embodiment in which the rotors are driven utilising a chain drive.

FIG. 18 is a schematic side view of a rotor and cover assembly according to a preferred embodiment of the present invention.

FIG. 19 is schematic view of the configuration illustrated in FIG. 18 showing the passage of hay through the assembly.

FIG. 20 is a schematic front view of the configuration illustrated in FIG. 18 showing the top cover and the skid plate according to a preferred embodiment of the present invention.

FIG. 21 is a schematic plan view of the position of the top cover and skirt relative to the pair of rotors according to a preferred embodiment of the present invention.

FIG. 22 is an isometric view of a pair of rotors according to an embodiment of the present invention.

FIG. 23 is a schematic side view of a rotor and cover assembly according to a preferred embodiment of the present invention.

FIG. 24 is a front view of a second embodiment of the present invention with the drawbar in the transport position.

FIG. 25 is a schematic illustration of a preferred configuration of pulleys used in the embodiment illustrated in FIG. 24.

FIG. 26 is a schematic illustration of a preferred configuration of drive belts used in the embodiment illustrated in FIG. 24.

FIG. 27 is a partially exploded representation of a rotor with a drum, bottom dish and blade support assembly according to a preferred embodiment.

FIG. 28 is a schematic illustrated of a pair of rotors according to the second embodiment showing rotation direction.

FIG. 29 is a schematic illustration of product movement through and between rotors as illustrated in FIG. 28.

FIG. 29A is a schematic illustration of product output by the second embodiment of the present invention.

FIG. 30 is a schematic illustration of a preferred rotor assembly support frame with rotors and lower rotor support plate.

FIG. 31 is a schematic illustration of the rotor assembly support frame illustrated in FIG. 30 with preferred drive pulleys.

FIG. 32 is a schematic illustration of the configuration illustrated in FIG. 31 with gearbox.

FIG. 33 is a schematic illustration of a preferred rotor assembly in the operational condition.

FIG. 34 is a schematic illustration of the preferred fan drive configuration with the housings and supports removed for clarity.

FIG. 35 is a side view of the preferred second embodiment of the present invention.

FIG. 36 is a side view as illustrated in FIG. 35 showing movement of product with preferred rear doors facing in and rear diversion cover fitted for windrowing.

FIG. 37 is a side view as illustrated in FIG. 35 showing front cover movement.

FIG. 38 is a front view of the conditioner illustrated in FIG. 35 showing front cover fully raised, displaying the rotor lower support bracket with the rotor skid plate and a replaceable wear plate.

FIG. 39 is a front view of the conditioner illustrated in FIG. 38 in a lowered condition.

FIG. 40 is a front view of the conditioner illustrated in FIG. 38 in a raised condition.

FIG. 41 is a side view of the conditioner illustrated in FIG. 38 in a raised condition.

FIG. 42 is a side view of the conditioner illustrated in FIG. 38 in a lowered condition.

FIG. 43 is a side view of the conditioner illustrated in FIG. 38 showing the possible change in pitch angle of the preferred rear doors and rear diversion cover.

FIG. 44 is a side view of the conditioner illustrated in FIG. 38 showing the location of a preferred air foil

FIG. 44A is a detailed side view of the air foil illustrated in FIG. 44 with adjustor assembly.

FIG. 45 is a side view of the air foil illustrated in FIG. 44A showing the adjustment thereof.

FIG. 46 is a schematic illustration of an optional side entry air intake.

FIG. 46A is a more detailed view of the location illustrated in FIG. 46.

FIG. 46B is a partial cutaway view of the optional side entry air intake illustrated in FIG. 46.

FIG. 47 is a schematic illustration of a second embodiment of the present invention and the juxtaposition with a vehicle showing preferred attachment using an offset drawbar.

FIG. 48 is a schematic illustration top view showing the drawbar in transport position and one advantage thereof.

FIG. 49 is a schematic illustration of the configuration illustrated in FIG. 47 showing deployment of the condition into the working position.

FIG. 50 is a schematic illustration top view displaying left hand door in position to divert the side movement of the product to a rear movement.

FIG. 51 is a schematic illustration top view showing the preferred location for mounting hydraulic spool valves.

FIG. 52 is a detailed view of the preferred hydraulic spool valve location and configuration illustrated in FIG. 51.

FIG. 53 is a schematic view side view of a Harvester with standard harvester front.

FIG. 54 is a schematic view side view of a Harvester with an integrated conditioner used as a swath row harvester front.

FIG. 55 is a schematic illustration displaying a conditioner according to a second preferred embodiment of the present invention with tractor being used.

FIG. 56 is a top view depicting a fan assembly according to an embodiment of the invention.

FIG. 57 is a perspective side view depicting two fans of the fan assembly of FIG. 56.

FIG. 58 is a perspective view of a fan blade of the fan assembly of FIG. 56.

FIG. 59 is a perspective view of an alternative fan blade of the fan assembly of FIG. 56.

FIG. 60 is a top view depicting the fan assembly of FIG. 56.

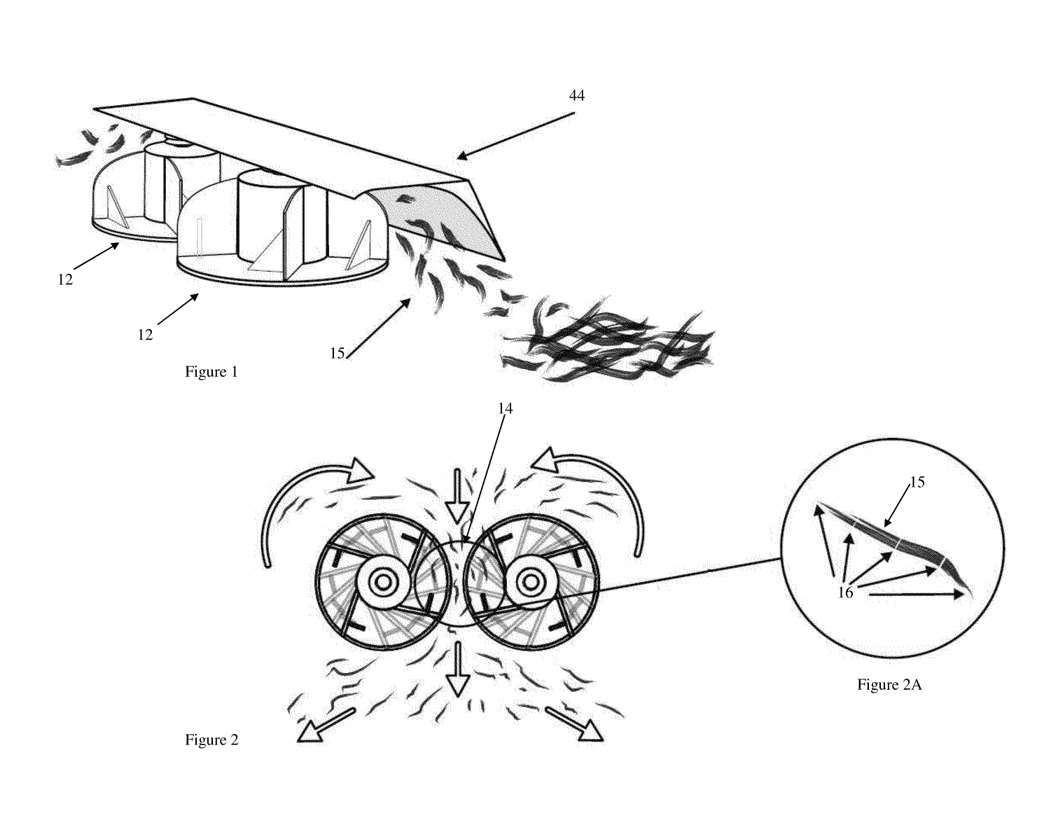

### DESCRIPTION OF EMBODIMENTS

According to a particularly preferred embodiment of the present invention, a hay conditioner 10 is provided.

The preferred embodiment of hay conditioner illustrated includes a draw frame 11 mounting a pair of counter-rotating rotors 12, each rotor 12 having a number of blades 13 in order to bruise the hay 15 and to convey the hay at least into a throat 14 located between the pair of rotors 12. This bruises the hay at a number of points 16 allowing the hay to dry more quickly.

The pair of rotors 12 of the hay conditioner are typically multipurpose rotors adapted to hasten drying of the hay by bruising the hay but also providing airflow which assists the drying process and also spreads the partially dried hay evenly behind the hay conditioner 10 in order to facilitate faster drying of the hay. This is illustrated generally in FIG. 2.

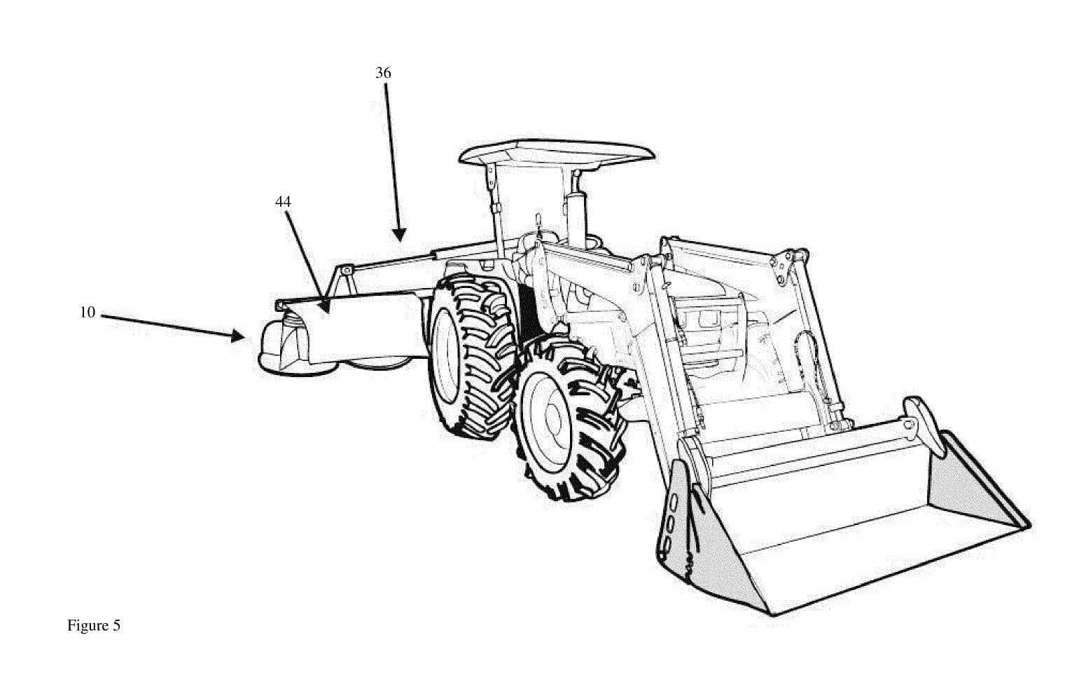

Typically, the draw frame 11 allows the hay conditioner to be drawn behind a vehicle, normally a tractor 16 as illustrated in FIGS. 5 and 6, which traverses an area of ground where hay has been cut and lays on the ground.

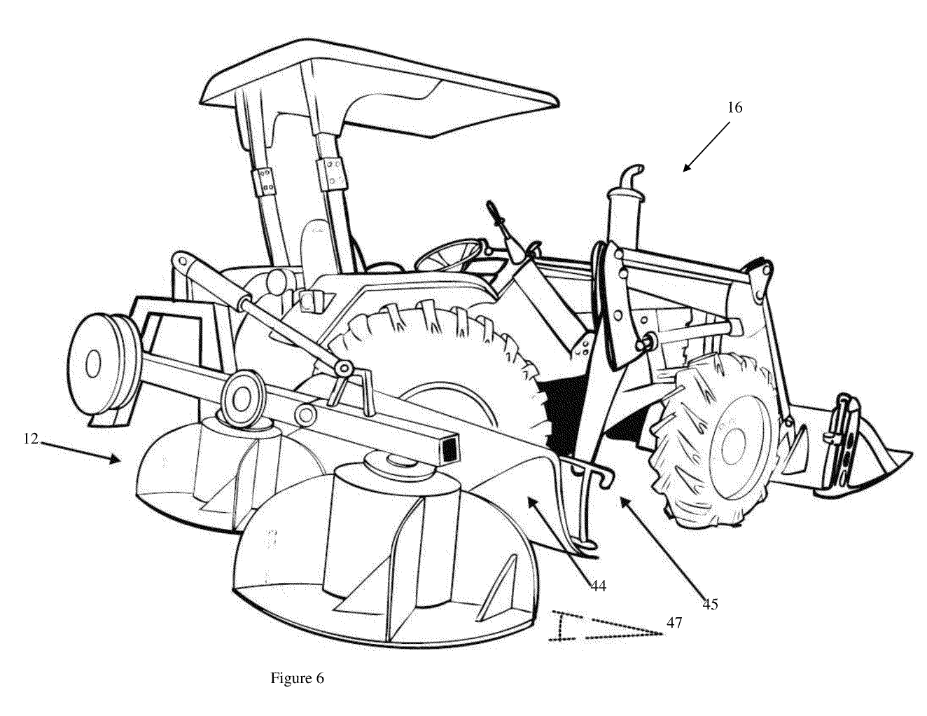

The draw frame may be of any configuration which is suitable to allow the hay conditioner to be drawn or otherwise mounted relative to a tractor. Typically, the tractor will have a three point linkage 17 or similar provided thereon as illustrated in FIG. 7 for example. Therefore, the draw frame will typically be adapted to mount to this linkage on the tractor 16 through frame linkages 18 provided. In the embodiment illustrated in FIG. 7, three linkage arms are provided to mount a main drive mounting frame 19 provided as a part of the draw frame.

The main drive mounting frame 19 of the illustrated embodiment mounts the main drive pulley assembly 20 driven by the power takeoff mechanism provided on the draw vehicle. In the embodiment illustrated in FIGS. 7 and 10, a pair of pulleys, one forward pulley 21 and one rear pulley 22 is provided mounted on the same pulley shaft 23.

As illustrated, the main drive mounting frame 19 is substantially A-frame in configuration but normally with a flattened upper section. The main drive mounting frame 19 is oriented in a substantially vertical plane and the main drive pulley assembly 20 rotate around a pulley shaft 23 which extends rearwardly of the main drive mounting frame 19.

The main drive mounting frame 19 is typically formed from a number of members, normally of metal box or similar members which are attached together to form the frame. According to a preferred embodiment, the lower member 24 of the main drive mounting frame 19 typically extends substantially horizontally across a lower extremity of the main drive mounting frame 19 below the lowest extremity of the main drive pulleys in order to protect the main drive pulleys and prevent contact of the main drive pulleys with the ground or hay on the ground.

A lateral extending frame assembly 25 is provided extending laterally from the main drive mounting frame 19.

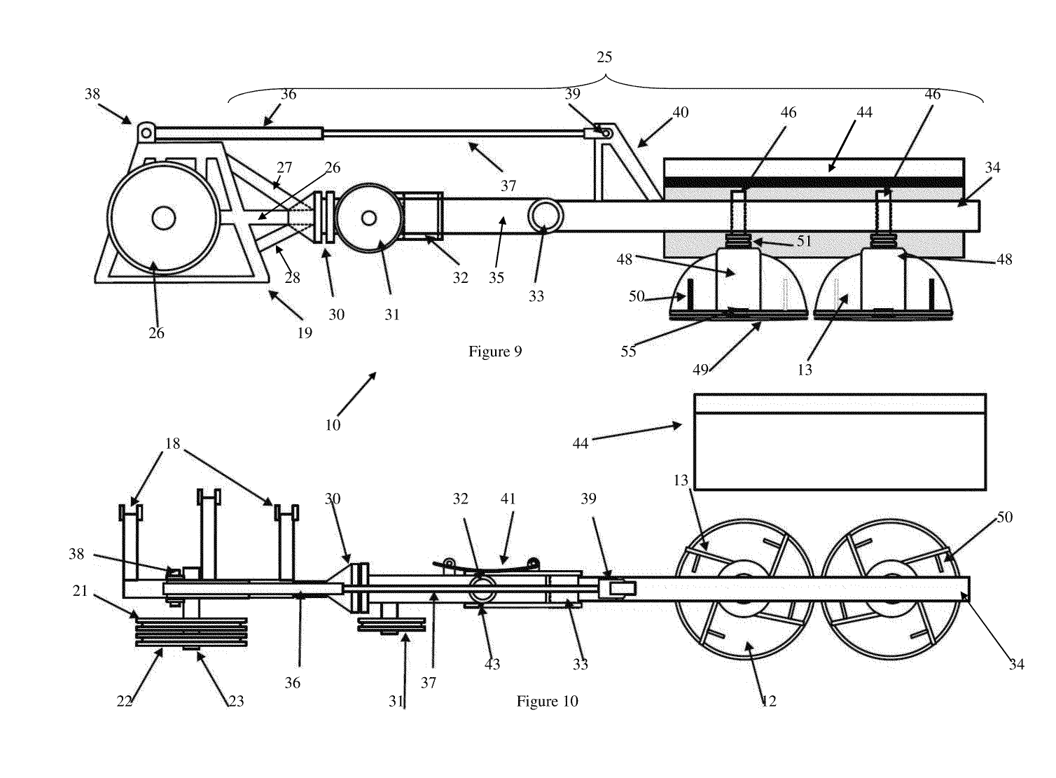

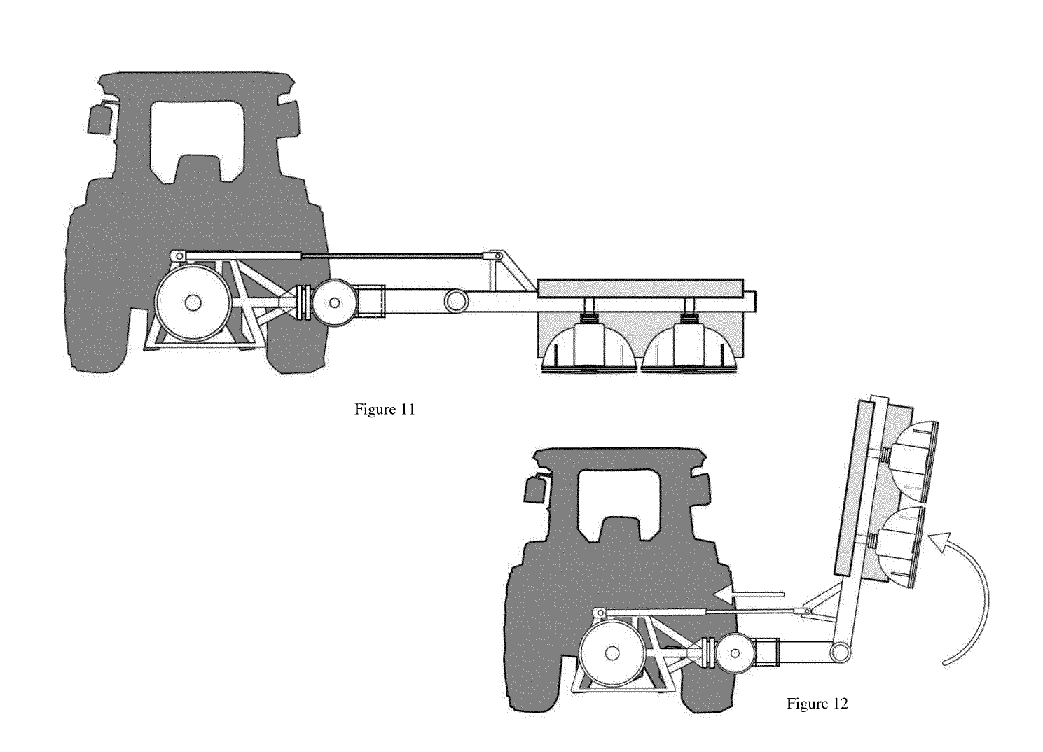

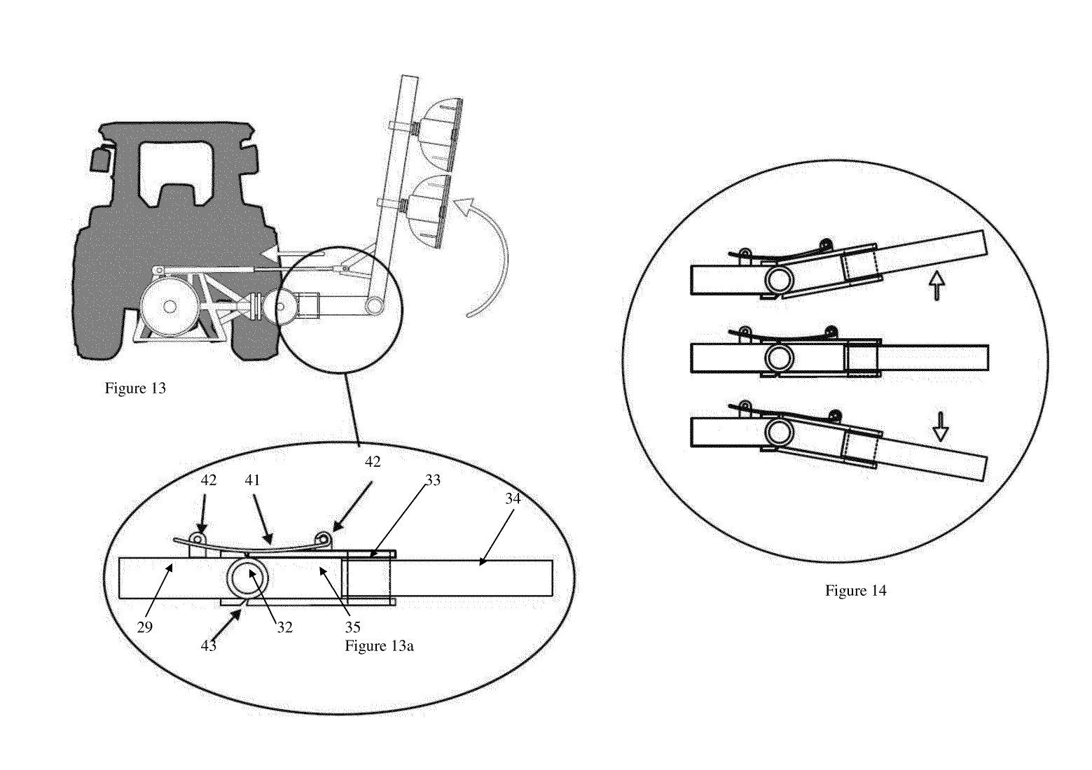

A main lateral bar 26 extends laterally sideways from one side of the A-frame main drive mounting frame 19. The main lateral bar 26 is braced into a particular orientation relative to the main drive mounting frame 19 through provision of an upper 27 and a lower bracing member 28 provided relative to the main lateral bar 26. Each of these upper 27 and lower members 28 is normally angled to brace the main lateral bar 26 into a substantially horizontal orientation as illustrated in FIG. 9.

A lateral arm 29 is normally provided mounted to or relative to the main lateral bar 26 on an outside end of the main lateral bar 26. Normally, the lateral arm 29 is mounted directly to the main lateral bar 26. An appropriate joining or mounting assembly is used and a preferred embodiment uses a flange join 30 with fasteners extending through mating flanges on the main lateral bar 26 and the lateral arm 29.

As illustrated, a secondary drive pulley 31 is mounted on the lateral arm 29. Normally, the secondary drive pulley 31 is mounted outboard of the flange join 30 between the lateral arm 29 and the main lateral bar 26.

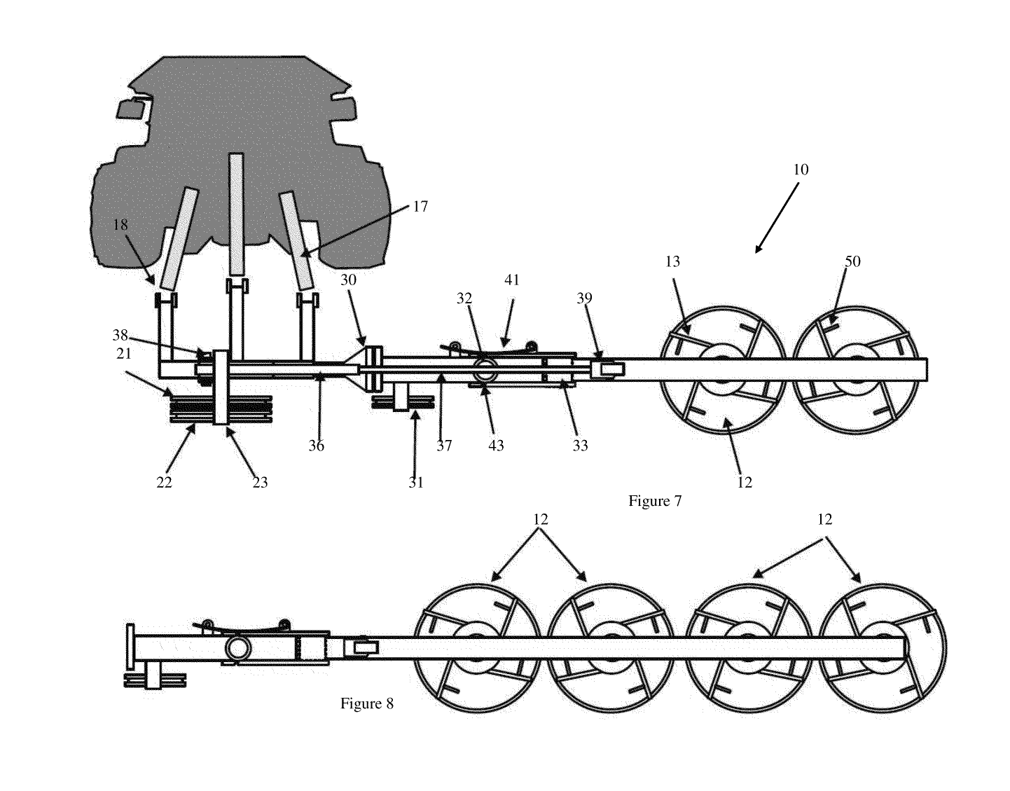

At least one pivot is typically provided over the laterally extending frame assembly 25. As illustrated in FIGS. 7 to 10, a horizontal pivot 32 is provided and a vertical pivot 33 is provided allowing a portion of the laterally extending frame assembly to move in both a horizontal direction and a vertical direction.

An outer arm 34 is provided relative to which the rotors 12 are mounted and the outer arm 34 is typically movable about the vertical pivot 33 in a vertical direction. An intermediate arm 35 is typically pivotally mounted relative to the lateral arm 29 allowing movement of the intermediate arm 35 in the horizontal plane about the horizontal pivot 32. A combination of both of these pivots allows optimal positioning of the rotors 12 through positioning of the outer arm 34 relative to which the rotors 12 are mounted.

The pivot allowing movement of the outer arm 34 through a vertical plane is powered in the illustrated embodiment in order to allow remote lifting of the outer arm 34 with the rotors 12 mounted thereto toward and away from the ground surface. This allows temporary reduction of the width of the vehicle as illustrated in FIG. 12 which can be important in certain circumstances such as when turning the vehicle and also when storing the vehicle with the hay conditioner mounted thereto.

According to the illustrated preferred embodiment, the pivot allowing movement of the outer arm through a vertical plane has an associated a hydraulic or pneumatic ram 36 with an elongate arm 37 to pivotally connect an inboard pivot point 38 on the main drive pulley frame 19 and an outboard pivot point 39 provided on a pivot frame 40 on the outer arm 34 allowing movement of the outer arm 34.

Therefore, according to the preferred embodiment, the lateral frame assembly 25 includes four components extending laterally, namely the main lateral bar 26 extending from the main drive frame 19, a lateral arm 29 which is mounted to an end of the main lateral bar 26, an intermediate arm 35 which is pivotally mounted to the lateral arm 29 allowing movement in a horizontal plane and an outer arm 34 which mounts the rotors 12 which is pivotally attached to the intermediate arm 35 allowing movement of in a vertical plane.

As illustrated, the components of the lateral frame assembly are all substantially coplanar and/or coaxial when the hay conditioner is in operation. A biasing assembly is provided that allows minimal movement of the intermediate arm 35 relative to the lateral arm 29 n a rearward direction and biases the intermediate arm 35 and therefore, the outer arm 34 against the friction force as the hay is being lifted into the rotors due to the pitch of the rotors 12. According to the preferred embodiment, a leaf spring 41 is provided on a forward side of the horizontal pivot 32 between two fixed points 42 allowing a minimal flexion of the intermediate arm 35 rearwardly under friction induced load. Small clearance gaps 43 are provided to allow this flexion without obstruction with adjacent components.

The outer arm 34 mounts the pair of rotors 12. The outer arm 34 also preferably mounts a cover 44 mounted on a cover mounting frame 45 in order to control or direct air and/or hay as desired.

Each rotor 12 is mounted for rotation about a substantially vertical shaft 46 although the angle of attack or pitch of the rotor 12 relative to the ground surface and/or the spacing of one or more rotors 12 in the pair is typically adjustable as required.

The hay conditioner of the present invention normally includes one pair of counter-rotating rotors but more than one pair of counter-rotating rotors can be provided for greater coverage or an extended lateral range.

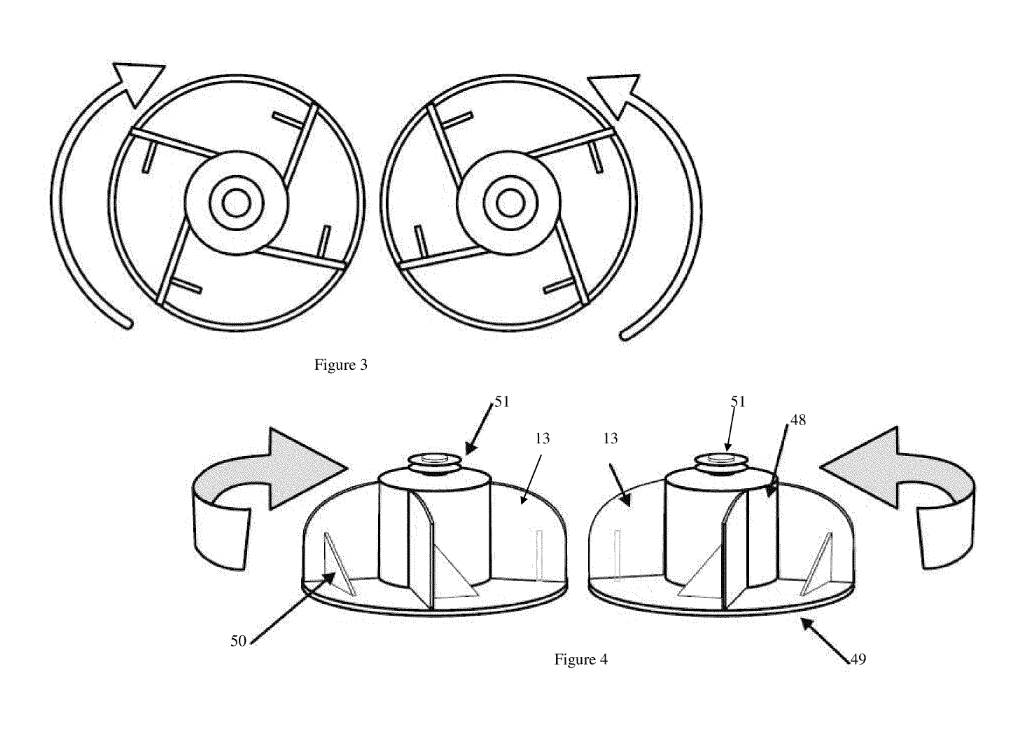

The counter-rotating rotors 12 of the preferred embodiment rotate in the directions illustrated in FIGS. 3 and 4. Provision of the counter-rotating rotors 12 in this configuration assists with drawing air and hay into the rotors at a forward side and helps to spread hay at the rear side.

Each rotor 12 is preferably angled downwardly at a forward edge and upwardly at a rear edge creating an angle of attack or pitch 47 for each of the rotors 12 as illustrated schematically on FIG. 6. Normally the pitch of the rotors 12 in each pair is substantially the same. The inclination or pitch of the rotors assists with drawing the hay into and through the rotors 12 as the vehicle traverses over the area having the cut hay on the ground. As mentioned above, this angle of attack or pitch is typically adjustable as is the clearance of the rotors from the cut hay and/or ground level.

Each rotor 12 is preferably similar in configuration although, due to the counter-rotating nature, the blade configuration on each rotor 12 in a pair will normally be a mirror image of the other rotor 12 in the pair. Each rotor 12 typically includes a substantially cylindrical central pillar 48 with a number of blades 13 provided extending radially from the central pillar 48. Normally, a circular flange 49 is provided at a lower end of the central pillar 48. The circular flange 49 extends radially outwards as well with the blades 13 mounted between the circular flange 49 and the central pillar 48. The circular flange 49 is normally welded 55 to the cylindrical pillar 48 and has a concave lower surface.

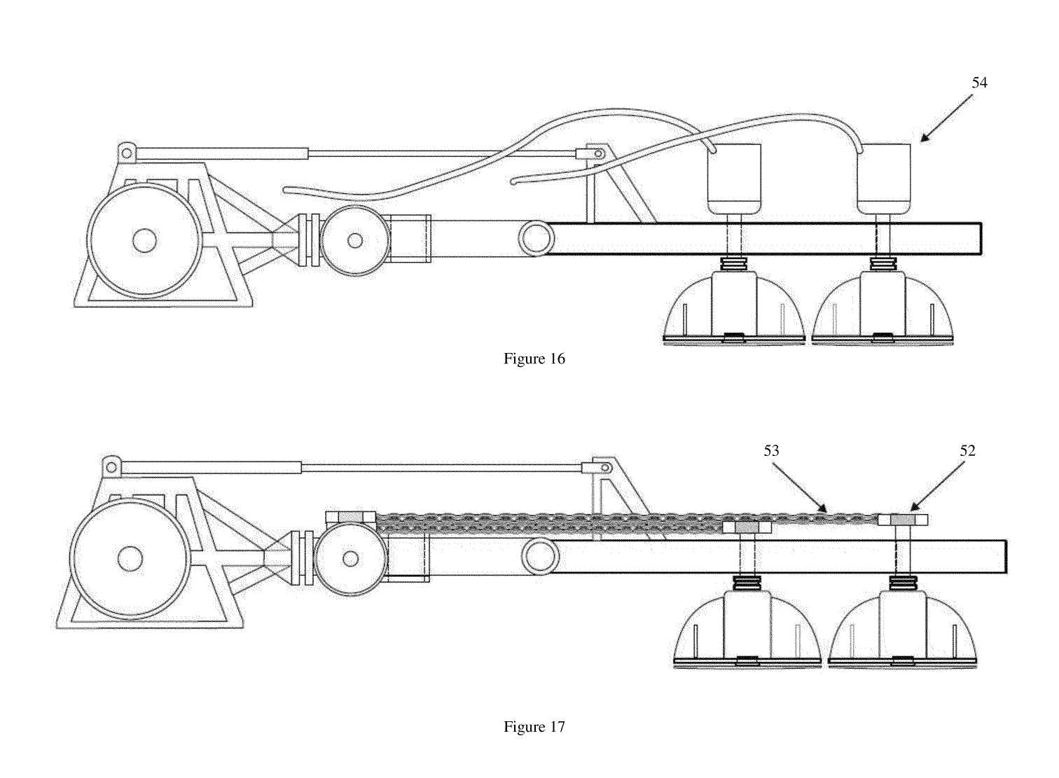

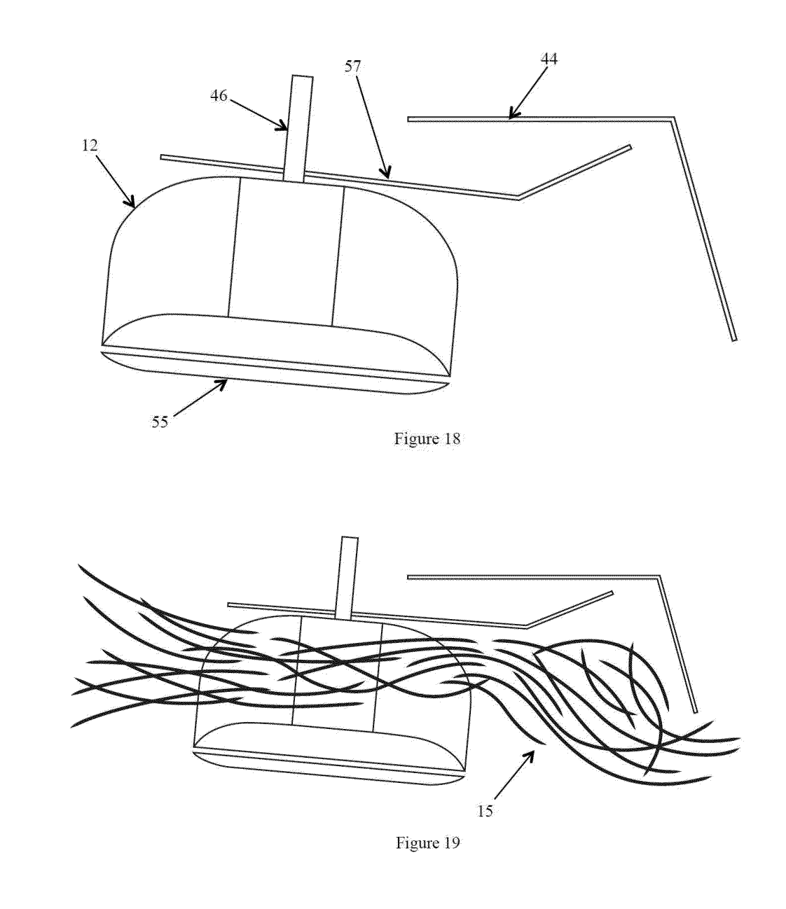

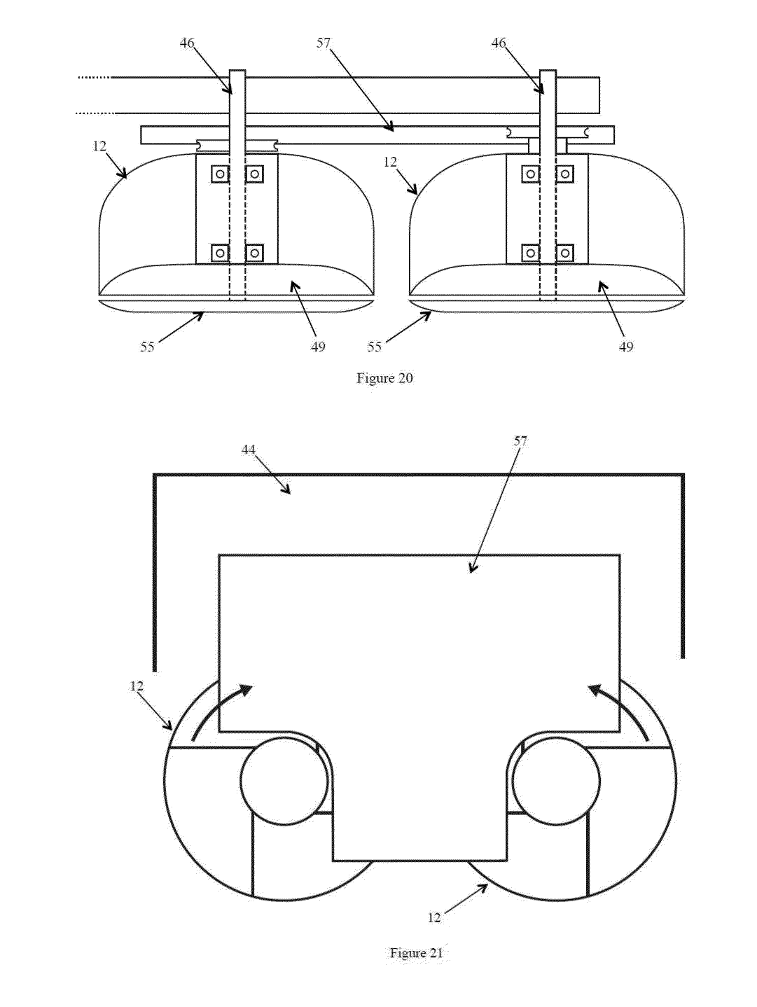

As illustrated in FIGS. 18 to 20, each rotor is mounted for rotation about a central shaft 46 received through a bore in the central pillar 48. The central shaft 46 is attached to the outer arm 34. Bearings are normally provided for balanced rotation. A lower portion of the central shaft mounts a skid plate 55 which allows the hay conditioner to “ride” across a ground surface. Outer portions of the skid plate 55 are appropriately shaped to minimise or prevent the skid plate 55 digging into the ground.

Normally, the blades 13 are spaced about the central pillar 48. Typically, each of the blades 13 extends substantially tangentially relative to the circular central pillar 48. According to the preferred embodiment, each blade 13 extends to or adjacent to the edge of the circular flange 49.

Each blade 13 has a substantially planar inner edge which abuts and is normally attached to the cylindrical central pillar 48. The outer edge of each of the blades is typically substantially planar and preferably coplanar with the edge of the circular flange 49. An upper edge of each blade extending between the outer edge and the inner edge is typically arcuate.

A bracing gusset 50 is provided behind each blade 13 (in the direction of rotation of the rotor) in order to minimise or prevent flexing of the blade 13. Preferably, each bracing gusset 50 is a solid, triangular, substantially planar plate which is attached to both the blade 13 and the circular flange 49, normally approximately halfway across the width of the blade.

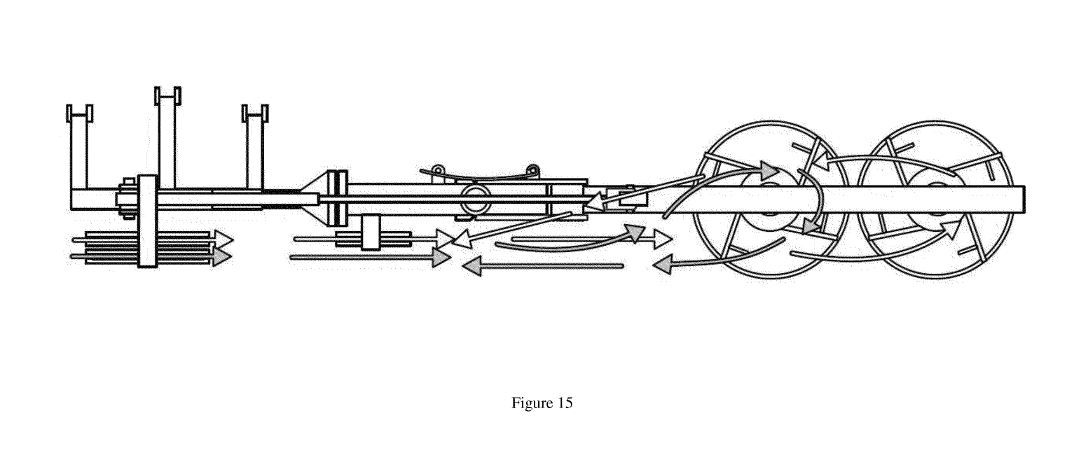

Normally, the cylindrical central pillar 49 mounts a portion of a drive mechanism in order to rotate the rotors 12. According to various embodiments, the drive mechanism may include one or more pulleys 51 provided for a belt drive such as is illustrated in FIGS. 3 to 10 and 15 or one or more cogs 52 provided for a chain drive 53 as illustrated in FIG. 17. Alternatively, each rotor 12 or pair of rotors 12 may be directly driven by a hydraulic, pneumatic or an electric motor 54 such as is illustrated in in FIG. 16.

Preferably, each rotor 12 in a rotor pair rotates at the same speed. However, different speeds may be used in order to distribute the condition hay exiting the rotors differently.

The outer arm also mounts a cover assembly in order to control or direct air and/or hay as desired. The cover also at least partially contains the air flow created by the rotors in order to lift and/or convey the hay. The cover assembly as illustrated in FIGS. 18 to 21 in particular includes a rigid top cover 57 to extend partially between the rotors 12, forwardly and laterally in order to minimise hay causing any problems with the drive for the rotors 12.

The cover assembly also preferably mounts a skirt 44 to assist with the air control and direction. The skirt 44 is mounted relative to the top cover 57 and extends forwardly of the top cover 57 and down in front of the rotors 12. The skirt 44 is flexible and a suitable material is a canvas or similar. The skirt will normally extend laterally across in front of the rotors as illustrated in FIG. 21.

A lower edge of the skirt 44 is typically spaced from the plane of the skid plate 55 so as not to obstruct the entry of the hay into the rotors 12.

In FIG. 22 there is illustrated an isometric view of a pair of rotors 12 according to an embodiment of the present invention. In this Figure, spreader members 70 are mounted to a number of the blades 13 of the rotors. The spreader members 70 are metal bars that are fixed at a first end thereof to the blades 13 while the opposed second end thereof (the end that extends outwardly from the blades 13) is pivotable relative to the blades 13 about the connection point between the first end and the blades 13. The spreader members 70 assist in drying the cut grass as it passes through the rotors 12. By adjusting the angle of the spreader members 70 relative to the blades 13 (which may be done depending on the type of grass being cut, the moisture content of the grass and the desired degree of drying) the drying of the cut grass may be improved.

In FIG. 23 there is shown a side schematic view of a cover and rotor assembly according to an embodiment of the present invention. In this embodiment of the invention, a flow control member 71 is located between the entrance 72 of the cover through which cut grass 73 enters and the rotors 12. The aerofoil shape of the flow control member 71 serves to direct the cut grass 73 into the rotors 12 for drying. This improves the efficiency with which the cut grass 73 is dried.

The flow control member 71 is mounted to the side walls of the cover assembly for pivotal movement about pivot point 74, as well as vertical movement along slot 75. In this way, the height of the flow control member 71 above the ground, as well as the angle of the flow control member 71 to the ground, may be adjusted as required. By adjusting the position of the flow control member 71, operational conditions such as the type of grass to be dried and the moisture content of the grass may be taken into consideration in order to achieve the desired degree of drying of the grass.

The hay conditioner of the present invention only needs a weather window of one day which means not only can a crop be cut at the right time for bulk, quality and nutritional value but there is less chance of losing nutritional value of the hay as the drying time is much quicker and the hay does not sun bleach. Labour and machinery hours are greatly reduced.

The present hay conditioner does not have to rely on the overnight dew and or moisture from rain to be evaporated from the crop before cutting can commence. A mower conditioner can cut the crop while still laden with moisture and the hay conditioner follows immediately behind the mower without waiting for the top layer of grass to dry.

The rotors of the hay conditioner create air flow which lifts and draws hay into the centre and in front of the two rotors. The hay is then drawn between the two rotors and discharged out of the rear of the machine.

As the hay is drawn through between the pair of rotors, the blades further bruise the hay to assist in the drying and curing process. This action dissipates visible moisture from the hay as well as dissipating some moisture, if any, from the ground in front of the rotors.

The hay is spread approximately five metres behind the machine and three metres wide leaving the hay in a fluffed up state to allow the sun and or breeze to dry one hundred percent of the hay evenly. This drying process usually takes between two to six hours depending on climatic conditions.

The hay is then raked into a wind row ready for baling which can commence immediately. Therefore, the hay is cut, conditioned, dried, cured, baled, transported and stored all in one day. As this process is done all in one day the bulk, quality and nutritional value of the hay is far greater than hay made on the fourth, third or even the second day after cutting with the currently available machinery.

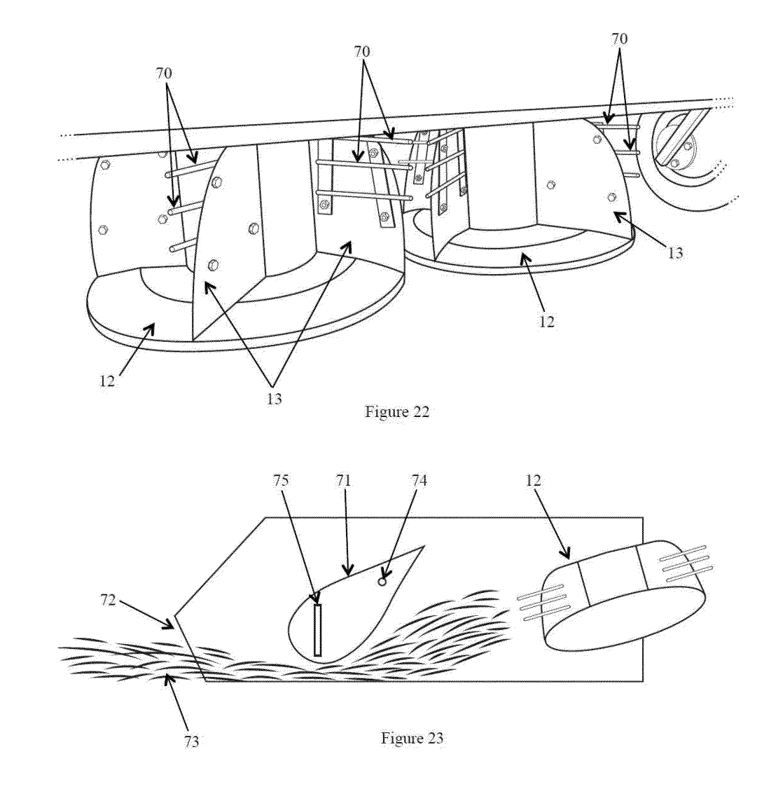

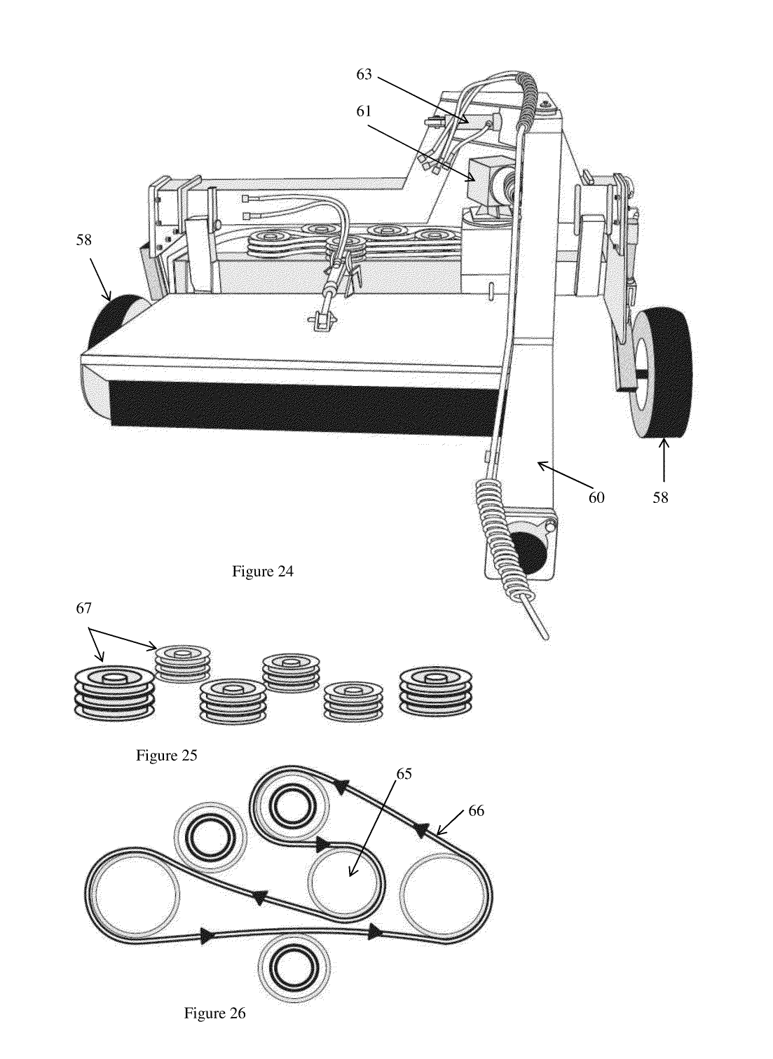

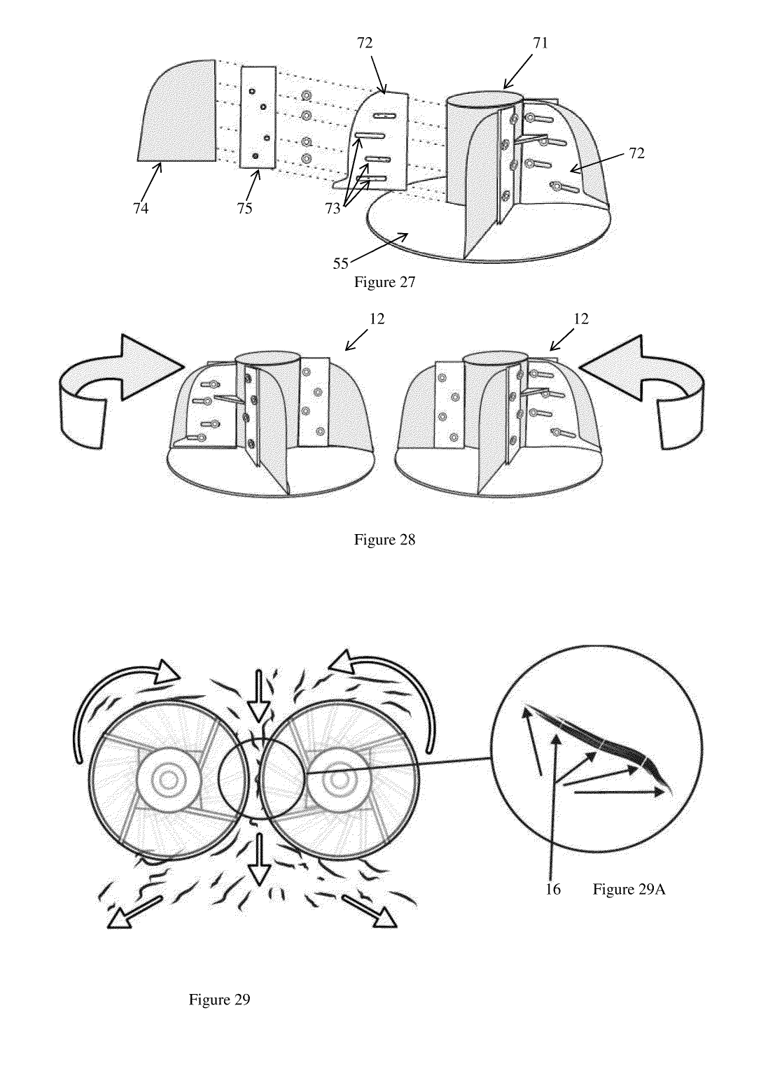

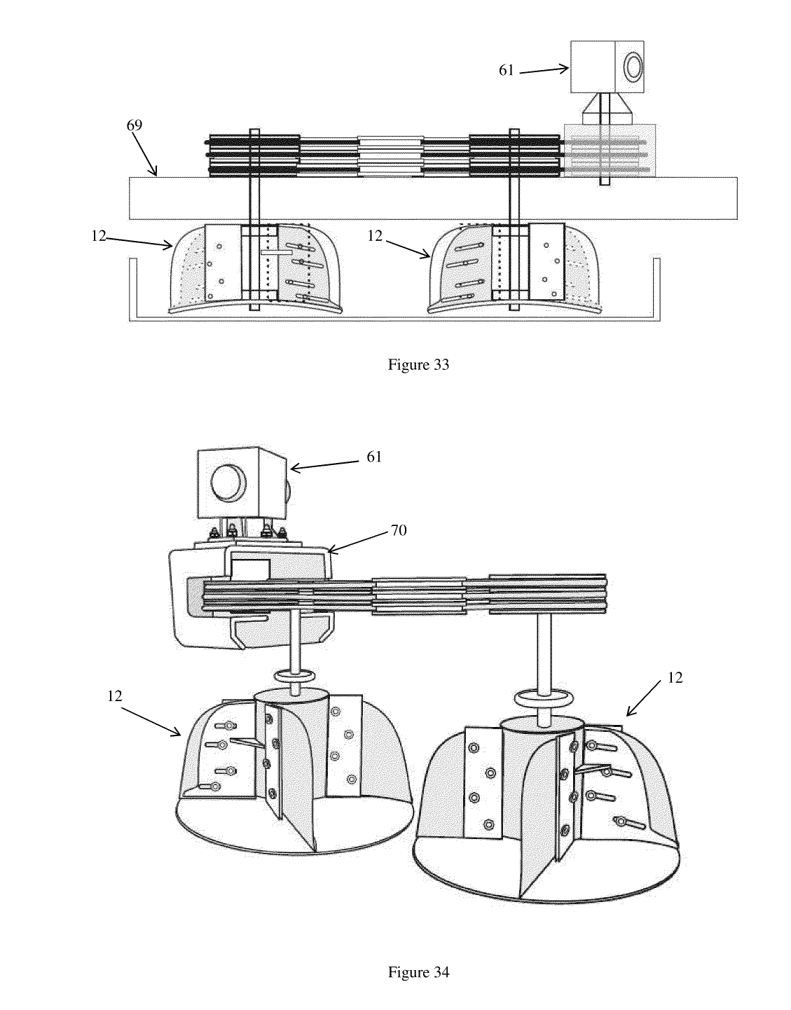

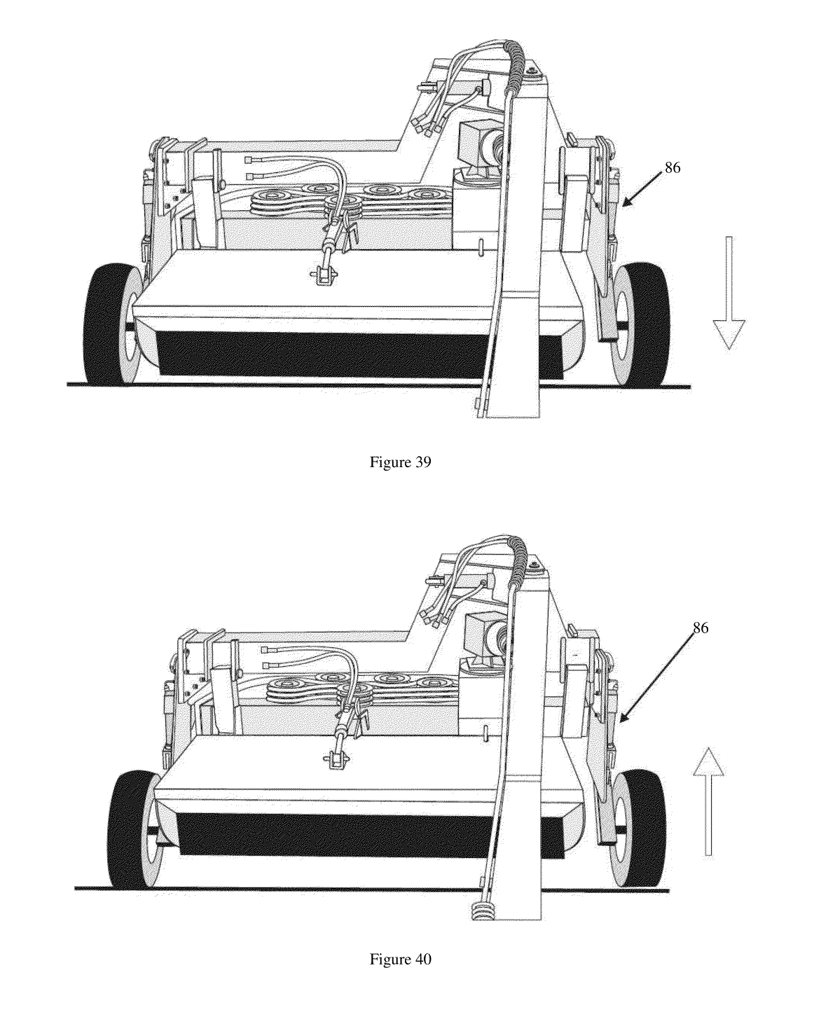

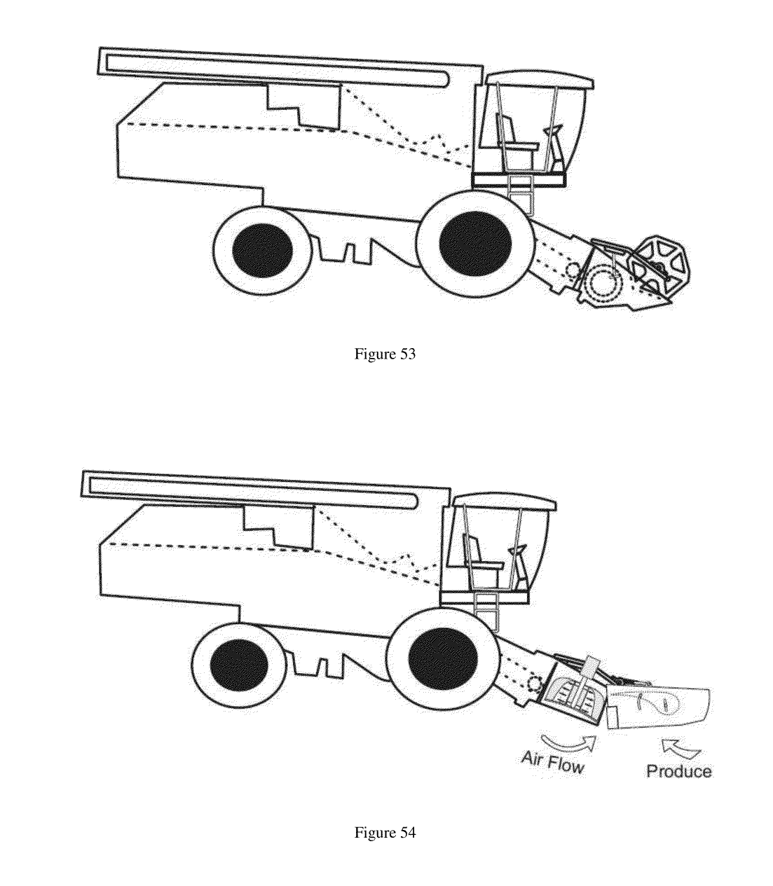

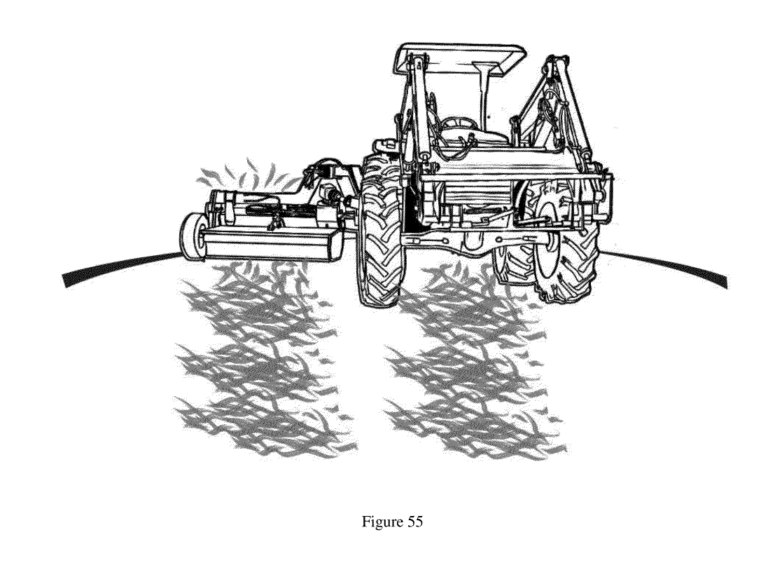

In a second preferred embodiment illustrated particularly in FIGS. 24 to 55, the conditioner is supported on wheels 58 and is drawn behind a tractor and is driven by a power take off (P.T.O.) assembly with a hydraulic adjustment system associated therewith.

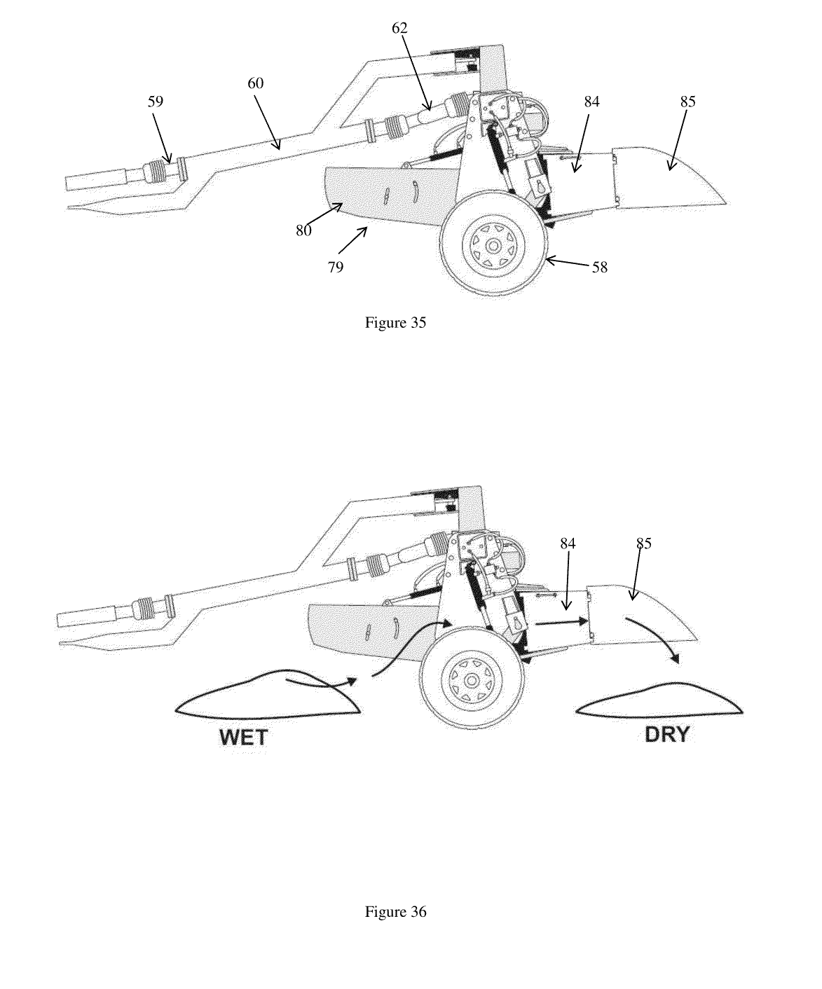

As illustrated in FIGS. 24 and 35 in particular, a drive shaft 59 of the PTO is housed inside an elongate draw bar 60 and is connected to a right angle drive gearbox 61 via a sliding shaft 62 with a universal joint at either end.

This allows the draw bar 60 to be swung from left to right from travel position for transport to working position as indicated generically in FIG. 24 with the drawbar 60 swung to the left, allowing the conditioner to travel behind, to the right hand side of the tractor.

This drawbar adjustment also allows for the conditioner whilst in its working position to be adjusted either closer or further away from the tractor. The drawbar 60 of the illustrated embodiment has a hydraulic ram 63 connected rearward of the drawbar pivot pin and is operated from the control panel in the tractor cab. This hydraulic ram 63 has a lockout valve fitted to lock the drawbar into the position required.

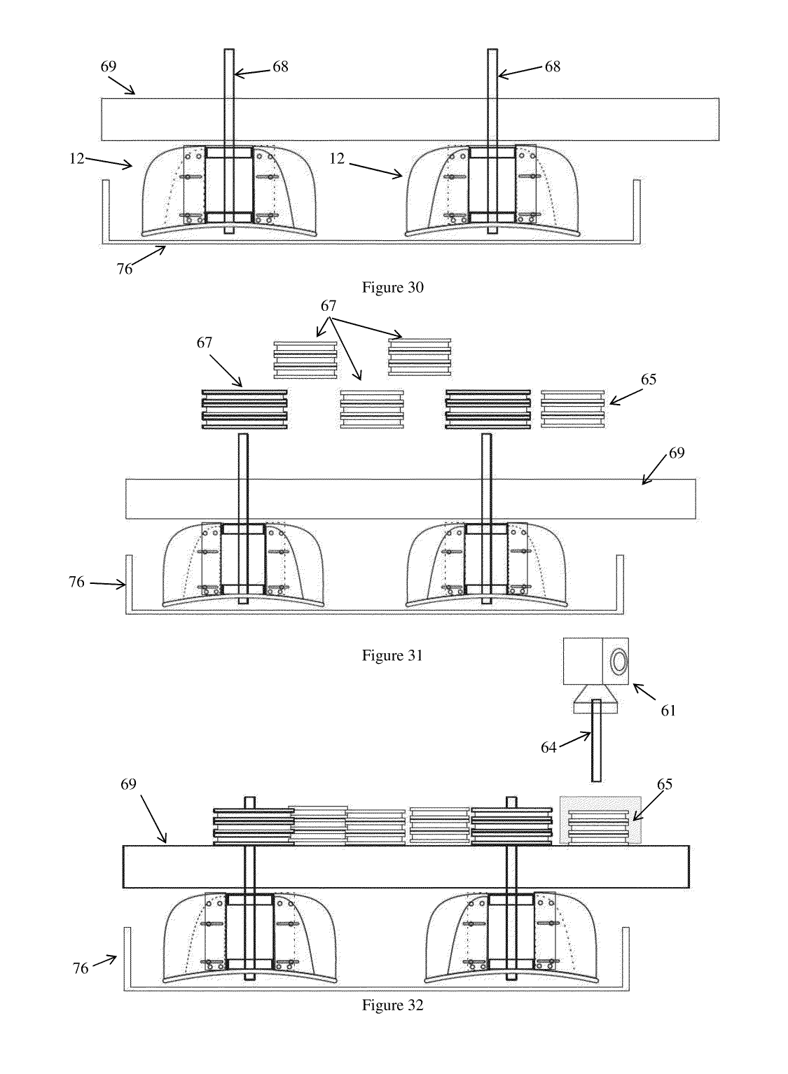

The drive shaft 59 is connected to the tractor's P.T.O also via a sliding shaft 62 with a single universal joint on the rear and an 80 degree double joint at the front of the shaft 59 to allow for tight turns while the machine is still running. The right angle drive gearbox 61 is mounted with its output shaft 64 facing down as illustrated in FIG. 32 in particular.

As illustrated in FIGS. 31 and 32, a three V pulley 65 is fitted to the output shaft 64. This pulley 65 drives three by double V belts 66 through a related system of pullies 67 which in turn drive the two rotors 12 in opposite directions as illustrated in FIGS. 26 and 31 to 34. There are two three v idler pulleys fitted to support the belts and one three v belt adjusting pulley as illustrated in FIG. 2. The pulley system is generally be covered by a housing 70.

The two rotors are each fitted with a three V pulley. However the use of a double sided cog belt could be used to drive the fans in this same configuration. The fans could also be driven by hydraulic motors, gears in a closed gearbox etc. The rotor assemblies include a centre shaft 68 fixed to a central drum of the rotor 12 and mounted through a main lateral support 69.

As illustrated in FIGS. 30 to 33 and 38, a lower rotor support plate 76 is provided to assist with support of the lower end of the rotors with the skid plate 55 of each rotor 12 extending further forwardly than the forward edge of the support plate 76.

A preferred form of rotor is illustrated in FIG. 27. A central cylindrical drum 71 is provided welded to the centre shaft 68 with a substantially circular concave skid plate 55 provided at the bottom of the drum and preferably also attached to the centre shaft 68. The upper end of the drum 71 is closed in and welded also to the shaft 68. Welded to the skid plate 55 and drum 71 are the rotor blade mounting brackets 72 which are gussetted back to the centre drum 71.

These rotor blade support brackets 72 have elongate openings 73 approximately 100 mm long to which the rotor blades 74 are mounted making them adjustable, sliding outward and inward to increase or decrease the size of the rotor diameter.

The rotor blades 74 are consumable and are replaceable. The inside edge of the fan blade is covered with a bolt-on deflection plate 75 to prevent the product wedging behind the fan blade. The deflection plate 75 clamps the blade to the rotor blade support brackets 72 through the elongate openings 73 using a number of fasteners.

At the bottom of the centre support shaft 68 for the rotor is a support bearing. The support bearings for both rotors are mounted to the support plate 76 which is mounted either side back to the main rotor assembly support frame 69. The rotor centre shaft 68 protrudes upward from the drum 71 and has two bearings supporting the shaft 68. These two bearings are mounted inside the rotor assembly support frame 69. The shaft 68 continues upward through the top of the support frame 69 where a three v driven pulley is then mounted to each rotor shaft 68.

The concave rotor skidplate 55 is secured to the underside of the of the fan support plate 75. A forwardly extending guide plate 77 with a replaceable wear plate 78 bolted to the front edge is provided beneath the rotors as illustrated in FIG. 38.

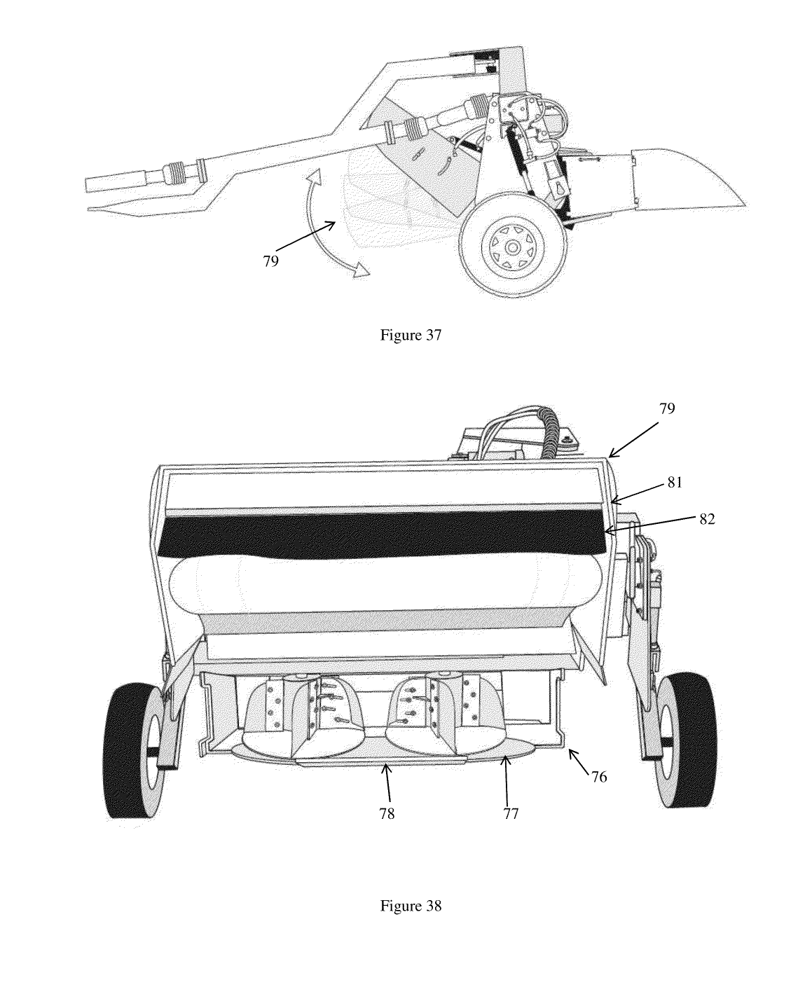

An entry assembly 79 including a front cover 81 with an air foil 80 is hinged to the front of the fan support frame 69. This front cover is fitted with a hydraulic ram 83 to lift and lower the entry assembly as illustrated in FIG. 37. A skirt 82 is provided transversely across the lower forward portion of the front cover to limit the loss of material forwardly of the rotors 12.

A safety guard is fitted to the rear of the fan support assembly.

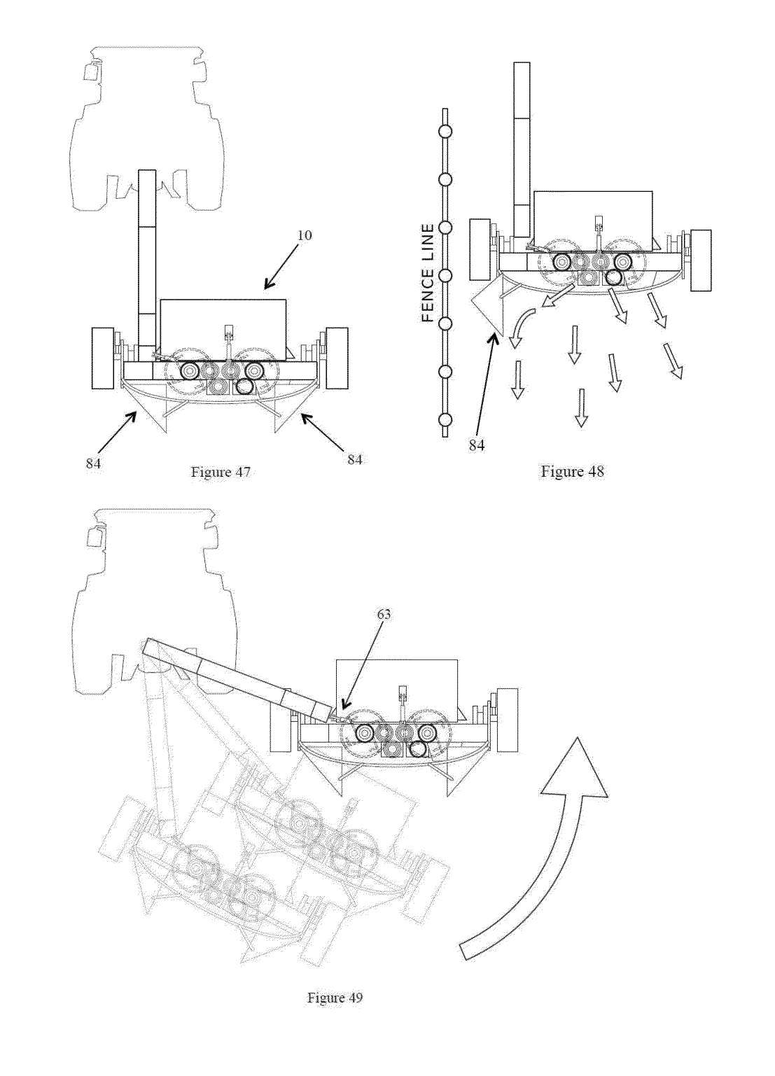

Two deflection doors 84 are hinged at the rear and either side of the rotor assembly support frame. The illustrated doors 84 are made in a triangular shape with the long 45 degree side-facing inward as best illustrated in FIGS. 47 and 48.

These doors 84 are made to be easily adjusted to vary the width of the product being dispersed from the rear of the machine. One or the other door 84 may be removed with the other being adjusted to an inward position to allow the product being spread in a particular direction such as is illustrated in FIG. 48.

Both doors 84 are removed for normal conditioning and spreading of the crop. In some cases the hay that has been dried and windrowed ready for baling becomes damp due to rain and or dew if it has been left overnight, making the moisture content too high for the baling process. In this case the moisture is external on the hay and does not need to be spread to dry the hay. The rear doors 84 can now be interchanged from one side to the other making the 90 degree side of the door inward closing up the rear of the machine as shown in FIG. 47.

A diversion cover 85 fitted to the rear of the doors 84 allows the machine to dry the windrow of visible moisture and leave it back into a windrow. The doors 84 can be attached relative to a stabilising bar 88.

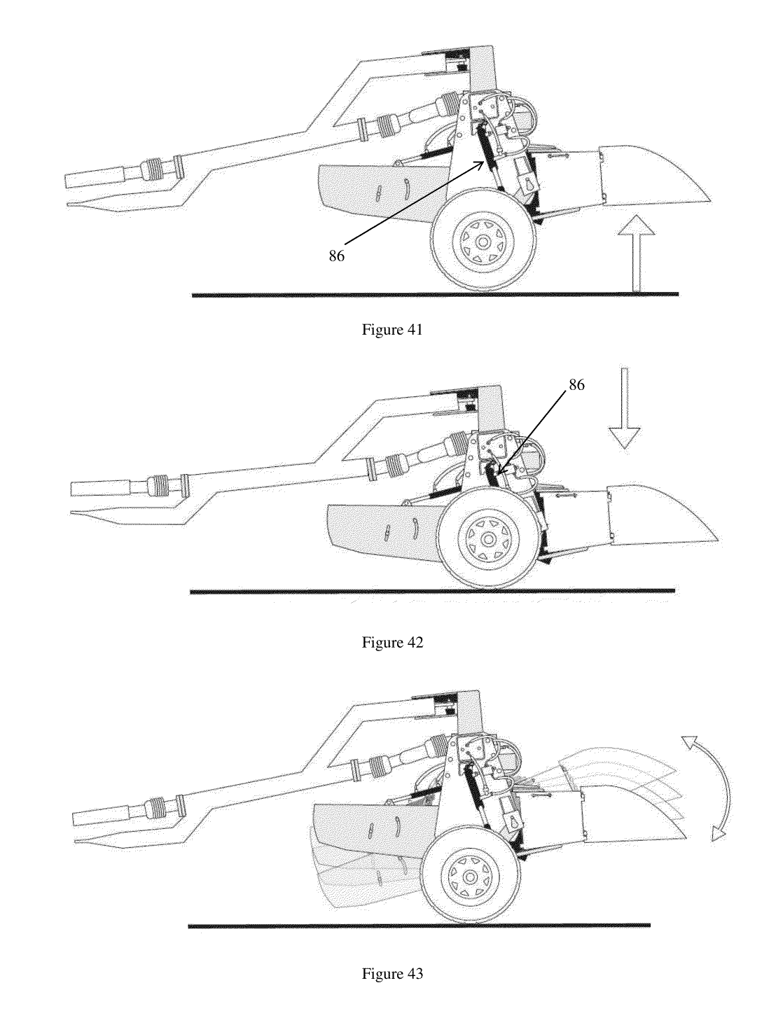

The rotor assembly main frame is preferably hinged to the main draw frame. This hinge assembly is fitted to the front side of the draw frame, on either side. Opposite each hinge to the rear of the main draw frame is a hydraulic ram 86. These rams 86 are contracted to raise and lower the rotor assembly to position the rotors at the correct operating height as illustrated in FIGS. 39 to 42. The assembly can also pivot relative to the frame as illustrated in FIG. 43 to provide the correct pitch or angle of attack.

After the correct angle is achieved, the entry assembly 79 is lifted or lowered via hydraulics to set the correct height. The air foil 80 mounted inside the front cover 81 of entry assembly 79 is set to the correct adjustment.

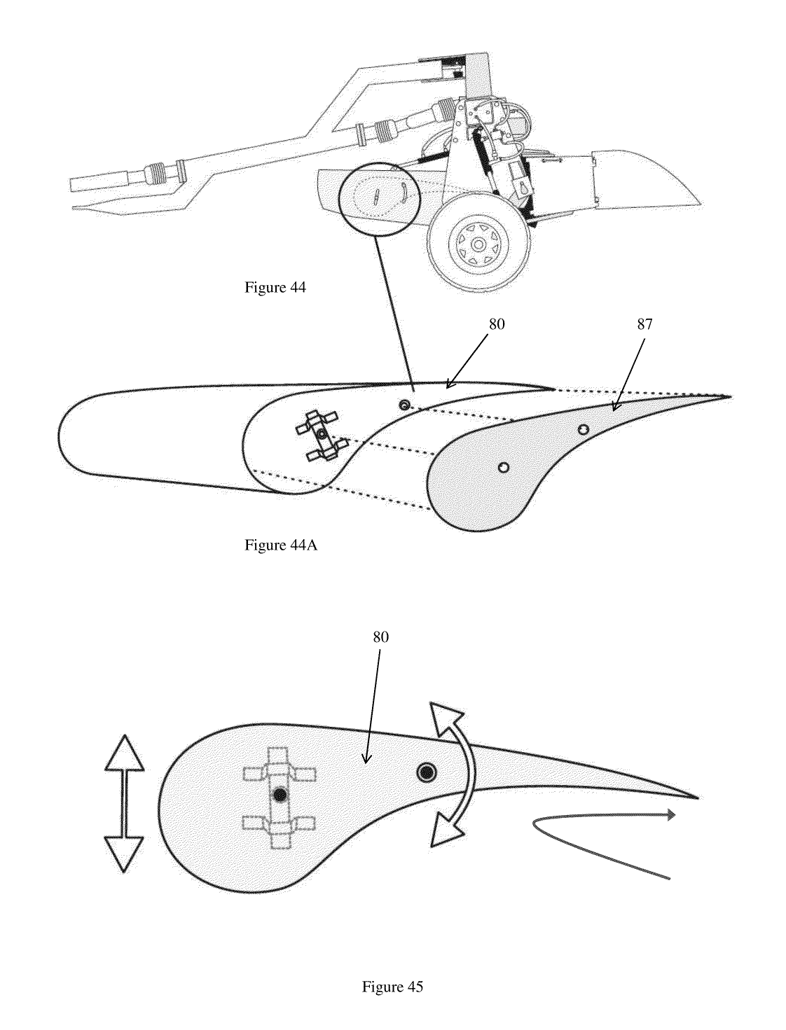

By lifting and lowering the front cover this then makes the air foil 80 at the correct height above the product. This height is critical to maximise the action of lifting the hay from the ground so as much of the hay is processed correctly as is possible. The machine height is then set by raising or lowering the main draw frame at the wheels. The mounting and adjustment of the airfoil 80 is illustrated in FIGS. 44 to 45. Different shapes of airfoil 80 can be used.

The entire rotor assembly can be separated from the draw frame. By simply disconnecting the front cover hydraulic hoses (on quick release) the P.T.O drive from the gearbox (quick release), the two bottom hydraulic ram pins are removed as well as the main hinge pivot pins with this process taking approximately two minutes. The main draw frame which has a wheel 58 at either side can be then lifted with the use of hydraulics above the rotor assembly and towed clear of the rotor assembly for ease of cleaning, repair and maintenance. Each wheel on the draw frame has a hydraulic ram fitted to raise and lower the machine. This height can be easily adjusted while the machine is operating. Each lift ram has a lockout valve to prevent the machine from dropping suddenly from hydraulic failure. An equaliser valve is fitted to ensure each of the two wheels raises and lowers equally keeping the machine level.

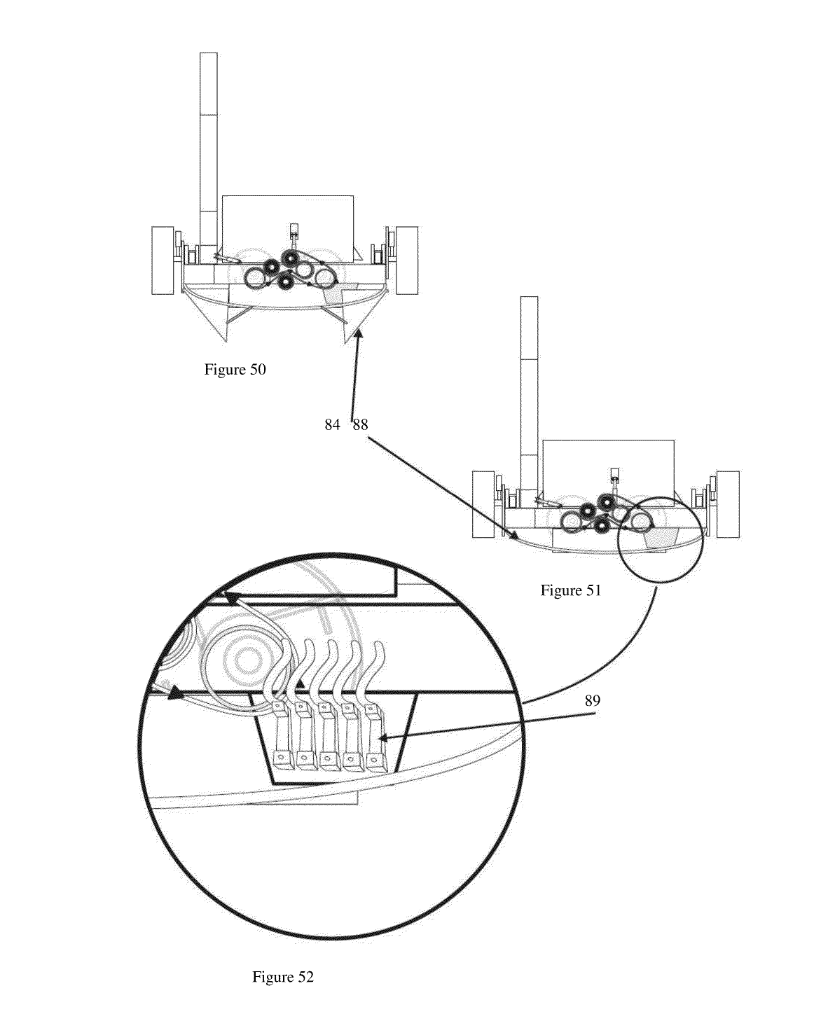

The hydraulic system operates from the tractor's remote hydraulics and has electric spool valves to operate the various movements. There is a manual switch panel wired to the spool valves and operated from inside the tractor cab. The spool valves 89 are mounted to the rear of the main draw frame as illustrated more particularly in FIGS. 50 to 52.

The adjustment mechanism for the air foil 80 as illustrated in FIGS. 44 to 45 has been designed in such a way that the air foil 80 can be adjusted in its entirety up and down. It can be adjusted leaving the rear of the foil in any position up or down and leaving the front of the air foil up or down. This is achieved by having a fixed female thread at the rear side of the air foil end plate and the front female thread is made adjustable up and down on a slide. An end cover 87 is welded to the end of the air foil 80 with the slide mechanism inward as illustrated

The air foil is mounted inside the front cover using two bolts at either end. The front adjusting slot is straight vertical, the rear adjusting slot is curved vertical. (Refer fig; 20)

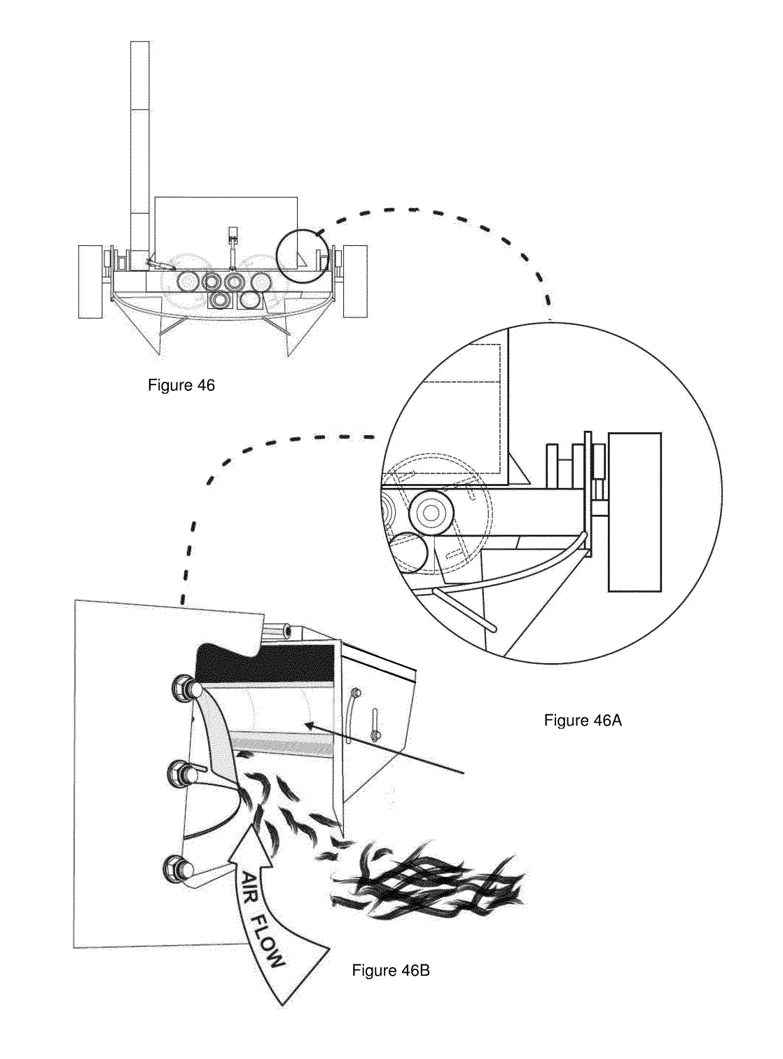

The two contra turning rotors, the left being clockwise the right being anti-clockwise draw the air from the outside and forward of the centre line of each rotor. Therefore an air intake is provided on either side of the assembly as illustrated in FIG. 46. With the pitch of the rotors facing down at the front this causes the air to be forced down toward the ground, this action lifts the hay from the ground. With the air foil 80 as low as possible at the front edge, (depending on crop volume) this causes the hay to be lifted upward and rearward at the back edge of the air foil 80 insuring the majority, preferably all of the hay is being lifted from the ground. The hay is then drawn rearward through and between the two fans to be discharged at the rear.

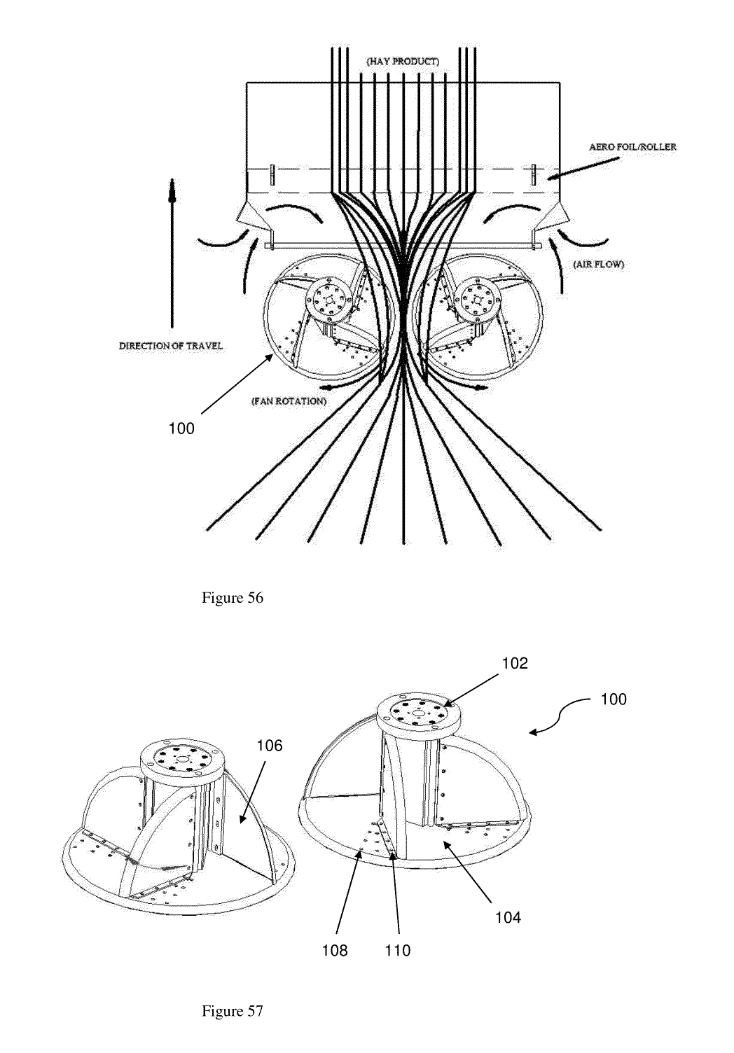

A second embodiment of the rotor assembly 100 is depicted in FIGS. 56 to 59. Each of the two rotor units 100 includes a central hub 102 and a lower fan blade support plate 104. In the embodiment depicted in FIGS. 56 to 59, four fan blades 106 (or vanes) are mounted to each rotor unit 100. However, it will be appreciated by those skilled in the art that more or less than four fan blades 106 may also be utilised.

The pitch of the fan blades 106 is variable. As shown in FIG. 57, the fan blade support plates include a plurality of radially extending holes 108. As depicted, there are three sets of holes 108, each set of holes 108 being generally linear and being angularly offset relative to the adjacent set of holes 108. The base of each fan blade 106 includes corresponding holes 110. As such, the holes 110 on each fan blade can be aligned with one set of the holes 108 to define an angular pitch position of the fan blade 106. Bolts or other fasteners are passed between the holes 108, 110 to secure each fan blade 106 to the support plate 104. Accordingly, a user can select the desired blade pitch angle. It will be appreciated by those skilled in the art that alternative means of changing the pitch of the fan blades 106 and securing the blades 106 may be deployed.

The inner edge of each fan blade 106 is bolted to a hinge secured to the fan hub 102. Adjusting the fan blade forward (in the direction of rotation) creates higher air velocity and a wider spread of product rearward.

In one arrangement, the two rotor units 100 are gear driven and timed to allow the fan blades 106 on each rotor unit 100 to be evenly spaced as they come together in the centre with their opposing rotation directions. Accordingly, one rotor unit 100 rotates in a clockwise direction, whilst the other rotor unit 100 rotates in a counter-clockwise direction. As such, each rotor 100 is angularly offset relative to an adjacent rotor unit 100 of the pair of counter-rotating rotor units 100, such that the blades 106 of each rotor unit 100 are rotationally staggered relative to the blades 106 of the adjacent rotor unit 100.

This arrangement is depicted schematically in FIG. 60, and allows for more even spread of hay or other such product, and permits an increased volume of product to be processed.

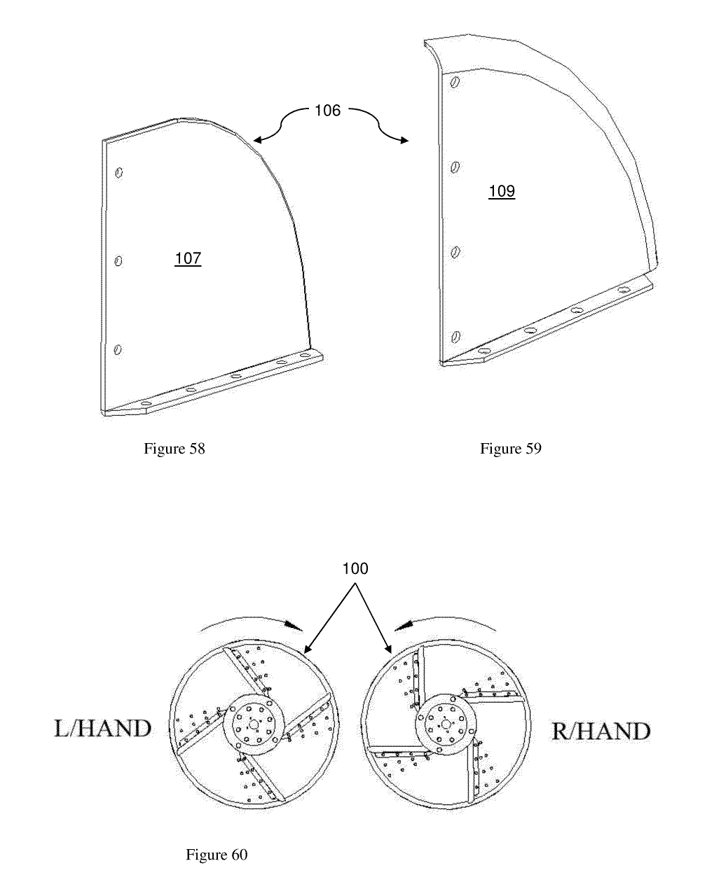

Referring to FIGS. 58 and 59, there are two types of blades 106 disclosed. The flat, generally planar blade 107 is used when a more vigorous action is needed to achieve the correct amount of bruising. Alternatively, the blade 109 depicted in FIG. 59 has a curved, outer edge which is used when a gentler action is required.

The rotor speed is variable and adjusted by tractor P.T.O. rpm. The P.T.O. shaft is usually driven at a speed of between 600 rpm and 800 rpm driving each rotor at approximately 1300 rpm to 1600 rpm. This speed is however determined according to crop type and volume. The rotor blades can be adjusted inwards decreasing the rotor diameter for large volume crops, however the rotor speed would need to be increased. The rotor speed is increased by increasing tractor engine rpm. The correct ground speed for an optimum result is adjusted by tractor gearing, leaving the P.T.O revs at the required speed to run the machine.

The rotor assembly with its front cover and air foil can be used in other applications other than a hay conditioner. One Example is a swath row harvester attachment for the front of a harvester such as illustrated in FIGS. 53 and 54.

Grain crops such as wheat, etc; can suffer storm damage when they are mature and just before harvesting leaving the grain head on the ground and lost. Pod crops such as peas, lentils etc; can also suffer storm damage leaving the pod on the ground. The Swath Row Harvester Front fitted to a standard harvester would be used to salvage storm damaged crops. The harvesting process of many pod crops is to cut the crop leaving the plant with its pod attached in a windrow.

A percentage of these pods are during this process lost from the plant and cannot be retrieved from the ground. A harvester follows immediately behind to pick up and process the product in the windrow. The harvester front on most modern harvesters is easily detached from the harvester and a different type of front can be easily fitted. This front could be used to pick up the freshly cut windrow also recovering all seed pods previously lost to the ground. The remaining standing crop left from a storm would still need to be cut and windrowed. The principal of the present invention is forcing air to the ground lifting the crop allowing all light products such as seed heads, pods and straw to be lifted and discharged rearward and into the front of the harvester to be processed by the harvester. This rotor principle picks up all light material leaving behind on the ground stones, sticks etc that could damage the harvester. As grain harvesters are self-propelled and hydraulic driven the Swath Row Front rotors can easily be hydraulic drive. A normal harvester front is driven from a separate drive at the front of the harvester. This drive could also be utilised to drive the rotors. Hydraulic rams would still be used to change rotor pitch and front cover height and machine height would be adjusted by simply lifting the existing harvester front mount assembly. This front mount assembly on a standard harvester has an elevator to convey the crop into the machine to be processed.

FIG. 53 shows a harvester with a standard harvester front. FIG. 54 shows a harvester fitted with a modified version of the present invention called a Swath Row Harvester Front.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A hay conditioner including a frame mounting at least one pair of counter-rotating rotors, each rotor having a number of blades in order to bruise the hay and which create airflow that lifts and draws the hay into the centre and in front of the pair of rotors to convey the hay at least into a throat located between the pair of rotors.

2. The hay conditioner as claimed in claim 1 wherein the hay conditioner is mounted relative to a vehicle to traverse over an area of ground.

3. The hay conditioner as claimed in claim 2 wherein the conditioner is driven by the power takeoff (PTO) mechanism provided on the draw vehicle.

4. The hay conditioner of claim 1, wherein a main drive mounting frame is provided with drive system including at least one pulley for each rotor and at least one drive belt associated therewith to drive the rotors.

5. The hay conditioner of claim 1 wherein the at least one pair of counter-rotating rotors are mounted relative to a rotor assembly movable relative to a main support assembly supporting the rotor assembly above a ground surface.

6. The hay conditioner as claimed in claim 5 wherein the rotor assembly is movable up and down in a substantially vertical direction to adjust a separation distance between the rotors and a ground surface.

7. The hay conditioner as claimed in claim 5 wherein the rotor assembly is pivotally movable to adjust an angle of attack of a forward portion of the rotor assembly relative to a ground surface.

8. The hay conditioner as claimed in claim 5 wherein the rotor assembly is mounted laterally offset from the main support assembly.

9. The hay conditioner of claim 1, wherein an assembly is provided allowing temporary reduction of the operating width of the conditioner.

10. The hay conditioner of claim 1, wherein a housing assembly is provided to at least partially confine the rotors and material to be conditioned.

11. The hay conditioner as claimed in claim 10 further comprising at least on flow control member extending substantially laterally across the width of the housing assembly within the housing assembly.

12. The hay conditioner as claimed in claim 11 wherein the at least one flow control member has an aerofoil shape and is adjustable in position and orientation.

13. The hay conditioner of claim 1, wherein the rotors are mounted for rotation about a substantially vertical axis although the angle of attack or pitch of the rotor relative to the ground surface and/or the spacing of one or more rotors in the pair is adjustable.

14. The hay conditioner of claim 1 wherein the rotors rotate such that a forward side of the rotors in the direction of travel converges rather than diverges.

15. The hay conditioner of claim 1, wherein each rotor is preferably angled downwardly at a forward edge and upwardly at a rear edge, creating an angle of attack or pitch for each of the rotors.

16. The hay conditioner of claim 1, wherein the blades are selectively adjustable to alter a pitch angle of each rotor blade.

17. The hay conditioner of claim 1, wherein each rotor is gear driven, further wherein each rotor is angularly offset relative to an adjacent rotor of the pair of counter-rotating rotors, such that the blades of each rotor are rotationally staggered relative to the blades of the adjacent rotor.

18. A rotor for conditioning material, the rotor including a central body, a lower skid plate mounted to the body and at least one rotor blade assembly mounted to the central body above the skid plate, the rotor positioned and oriented in use closer to a ground surface at a forward side than a rearward side to lift and propel material from adjacent a ground surface in a desired direction.

19. The rotor of claim 18 wherein the skid plate of the rotor is concave on a lower side.

20. The rotor of claim 18 wherein the rotor is provided with one or more spreader members relative to at least one rotor blade assembly.

21. The rotor of claim 20 wherein two or more spreader members are present, the two or more spreader members located spaced apart from one another at a suitable distance, and at a suitable angle to one another depending on the type of material being conditioned.

22. The rotor of claim 21 wherein spreader members are located on at least one blade of at least one rotor.

23. The rotor of claim 18, wherein the rotor blade assembly is selectively adjustable to alter a pitch angle of each rotor blade.

24. The rotor of claim 23, wherein the skid plate includes a first hole adapted to align with a corresponding second hole formed on the rotor blade, the first and second holes being adapted to receive a fastener, further wherein the rotor blade is pivotally connected to the central body.

25. The rotor of claim 24, wherein each blade has a generally planar profile.

26. The rotor of claim 24, wherein each blade has a generally planar blade body portion and non-planar blade edge region which curves away from the blade body portion.
